(19) United States
(12) Patent Application Publication
(10) Pub. No.: US 2012/0190225 A1
(43) Pub. Date: Jul. 26, 2012

(54) PLUG RECEPTACLE

(75) Inventors: Keisuke Bessyo, Osaka City (JP); Kouji Higashide, Osaka City (JP); Takashi Kawamoto, Mie City (JP); Toshiyuki Takii, Mie City (JP)

(73) Assignee: Panasonic Corporation, Osaka (JP)

(21) Appl. No.: 13/389,349

(22) PCT Filed: Aug. 3, 2010
(86) PCT No.: PCT/IB2010/001908

§ 371 Date: Apr. 17, 2012

(30) Foreign Application Priority Data
Aug. 7, 2009 (JP) 2009185057
Aug. 7, 2009 (JP) 2009185059
Aug. 7, 2009 (JP) 2009185060
Aug. 7, 2009 (JP) 2009185280
Sep. 24, 2009 (JP) 2009219730
Nov. 24, 2009 (JP) 2009266751

(51) Int. Cl. H01R 24/00; H01R 29/00

(52) U.S. Cl. 439/177; 439/660

(57) ABSTRACT

A plug receptacle includes a housing having at least one outlet unit to which a plug is adapted to be connected to supply a DC power to the plug, and a cable, connected to the housing, for supplying the DC power to the housing. The outlet unit includes a plug-receiving portion having a plurality of substantially circular pin-inserting holes into which plug pins of the plug are inserted and an insertion groove formed to surround a periphery of the plug-receiving portion. The plug-receiving portion has a substantially quadrangular shape viewed from a front side thereof. The insertion groove is adapted to receive a surrounding wall of the plug and has a substantially quadrangular shape viewed from the front side. The pin-receiving holes are arranged along one side of the plug-receiving portion serving as a reference side and offset closer to the reference side than an opposite side to the reference side.

### FIELD OF THE INVENTION

The present invention relates to a plug receptacle to which a plug is adapted to be connected, and including a housing having an outlet unit for supplying DC power to the plug and a cable connected to the housing.

### BACKGROUND OF THE INVENTION

Conventionally, there has been known a plug receptacle having an outlet unit to which a plug of an electric device such as a personal computer or a phone is detachably connected to and serving to supply an operation power (AC power) to the electric device through the plug, e.g., table tap (see, e.g., Japanese Patent Application Publication No. H07-211384 (JP07-211384A)).

In the meantime, most of electric devices make use of direct current (DC) power as their drive power. For that reason, the alternating current (AC) power supplied from an AC outlet is converted to DC power by an AC-DC converter and then fed to the electric devices. Power loss occurs when the AC-DC converter converts the AC power to the DC power. In an effort to prevent such power loss, there is known a DC outlet for supplying DC power to electric devices (see, e.g., Japanese Patent Application Publication No. H07-15835 (JP07-15835A)). Use of the DC outlet makes it possible to omit an AC-DC converter which would otherwise be provided between the DC outlet and the electric devices. Two kinds of plugs usable with this DC outlet are known in the art, one of which has a single plug pin as disclosed in JP07-15835A and the other of which has two plug pins complying with IEC Standards.

In the plugs having two plug pins, the plug pins are divided into a positive pin and a negative pin. Correspondingly, the DC outlet is provided with a positive-pin insertion hole into which the positive pin is inserted and a negative-pin insertion hole into which the negative pin is inserted. With the configuration of two plug pins and two insertion holes, it is sometimes the case that the positive pin is inserted into the negative-pin insertion hole while the negative pin is inserted into the positive-pin insertion hole (namely, reverse insertion occurs). Taking this into account, the DC outlet is provided with a structure for preventing the reverse insertion.

As compared with the AC outlet, it is likely in the DC outlet that the arc generating between the DC outlet and the plug becomes sustained if the plug is removed from the DC outlet during power delivery. In order to make the arc invisible from the outside of the plug, the plug is provided with a surrounding wall for externally covering the plug pins. As an example of the DC outlet having the surrounding wall and the two plug pins, there is available a DC outlet complying with IEC Standards.

Referring to FIGS. 21A and 21B, description will be made on a DC outlet and a plug complying with IEC Standards.

As shown in FIG. 21A, a plug 100 includes two positive and negative plug pins 101 for electric connection with the outlet unit of a DC outlet (hereinafter referred to as “outlet unit 110”) and a cylindrical surrounding wall 102 for externally covering the plug pins 101. A rib 103 protruding downwards is provided in the upper end portion of the surrounding wall 102 along the vertical direction. The plug pins 101 are arranged in the same position as the center CR1 of the surrounding wall 102 in the vertical direction and spaced apart from the center CR1 in the horizontal direction.

As illustrated in FIG. 21B, the outlet unit 110 includes an insertion groove 111 into which the surrounding wall 102 is inserted and a plug-receiving portion 112 surrounded by the insertion groove 111. The insertion groove 111 is formed into an annular shape in a plan view as seen in the insertion direction of the plug 100. A keyway 113, into which the rib 103 is inserted, is provided in the upper end portion of the insertion groove 111 along the vertical direction. In the plug-receiving portion 112, there are formed two pin insertion holes 114 into which the plug pins 101 of the plug 100 are inserted. The pin insertion holes 114 are arranged in the same position as the center CR2 of the insertion groove 111 in the vertical direction and spaced apart from the center CR2 in the horizontal direction.

The plug 100 and the outlet unit 110 are connected to each other by inserting the plug 100 into the outlet unit 110 in a state that the plug pins 101 are aligned with the pin insertion holes 114, the surrounding wall 102 with the insertion groove 111, and the rib 103 with the keyway 113.

In order to avoid reverse insertion of the plug 100 into the outlet unit 110, the plug 100 needs to be inserted into the outlet unit 110 with the rib 103 of the plug 100 aligned with the keyway 113 of the outlet unit 110. In other words, it is necessary for a user to align the rib 103 with the keyway 113 after the user visually confirms the position of the rib 103 provided in the surrounding wall 102 of the plug 100. Thus, the task of inserting the plug 100 into the outlet unit 110 becomes cumbersome and onerous.

As another outlet structure for preventing reverse insertion, it is thinkable to employ a configuration in which, in place of omitting the rib 103, pin insertion holes are provided in a position vertically off-centered from the center of a plug-receiving portion as shown in FIG. 22A. More specifically, as shown in FIG. 22A, an outlet unit 200 is provided with an insertion groove 201 having an annular shape in a plan view as seen from the front side in the front-back direction. Two pin insertion holes 203 are provided at the upper side of the center CR3 of a circular plug-receiving portion 202 surrounded by the insertion groove 201.

However, the horizontal width of the plug-receiving portion 202 grows smaller as the plug-receiving portion 202 extends upwards from the center CR3 in the vertical direction. Thus, the distance DR1 joining the two pin insertion holes 203 gets reduced. As a result, the distance joining the plug pins (not shown) of the plug inserted into the pin insertion holes 203 is reduced. This poses a problem of reducing the dielectric strength of the plug pins.

As a solution to this problem, it is conceivable to employ a configuration in which, as illustrated in FIG. 22B, the size of the plug-receiving portion 112 is increased by increasing the outer diameter DR2 of the insertion groove 201. This makes it possible to increase the distance DR5 between the two pin insertion holes 203 (so that DR5 becomes greater than DR1).

In addition, the DC outlet may have a configuration in which the pin insertion holes are in the form of rectangular through-holes, into which the flat pins (not shown) of a plug can be inserted, rather than circular through-holes.

More specifically, as shown in FIG. 23A, an outlet unit 300 is provided with an insertion groove 301 having a generally rectangular shape in a plan view as seen in the front-back direction. Two pin insertion holes 303 are provided at the upper side of the center CR 4 of a plug-receiving portion 302 surrounded by the insertion groove 301 (wherein the center CR4 denotes the intersection point of two diagonal lines joining four corners of the plug-receiving portion 302). The pin insertion holes 303 are formed into a rectangular shape whose long side extends in the vertical direction.

In case where the flat pins are formed to have the same cross-sectional area as that of the plug pins, the vertical dimension of the flat pins becomes greater than the vertical dimension of the plug pins. Thus, the pin insertion holes 303 are formed to extend long in the vertical direction. More specifically, the lower end portions of the pin insertion holes 303 extend downwards beyond the center CR4. Therefore, if the plug is reversely inserted into the outlet unit 300, the flat pins partially come into the pin insertion holes 303 and may possibly make contact with the pin rest members (not shown) of the outlet unit 300.

In view of this, it is conceivable to employ a configuration in which, as shown in FIG. 23B, the size of the plug-receiving portion 302 is increased by making the outer dimensions DR3 and DR4 of the insertion groove 301 greater than those of the insertion groove 301 illustrated in FIG. 23A. Thus, the entire portions of the pin insertion holes 303 are positioned at the upper side of the center CR4 in the vertical direction, which makes it possible to prevent reverse insertion. However, there is posed a problem in that the increase in the size of the plug-receiving portion 302 results in an increase in the size of the outlet unit 300.

### SUMMARY OF THE INVENTION

In view of the above, the present invention provides a DC outlet capable of preventing a plug from being reversely inserted thereto without being scaled up and easily aligning the plug therewith when the plug is connected thereto.

In accordance with an aspect of the present invention, there is provided a plug receptacle comprising a housing having at least one outlet unit to which a plug is adapted to be connected to supply a DC power to the plug, the plug including a plurality of plug pins having a circular bar shape; and a substantially quadrangular-shaped surrounding wall for surrounding the plug pins; and a cable, connected to the housing, for supplying the DC power to the housing, wherein: the outlet unit includes a plug-receiving portion having a plurality of substantially circular pin-inserting holes into which the plug pins of the plug are inserted, the plug-receiving portion having a substantially quadrangular shape viewed from a front side thereof; and an insertion groove formed to surround a periphery of the plug-receiving portion, the insertion groove being adapted to receive the surrounding wall of the plug and having a substantially quadrangular shape viewed from the front side; and the pin-receiving holes are arranged along one side of the plug-receiving portion serving as a reference side and offset closer to the reference side than an opposite side to the reference side.

A shape of at least one of the plug-receiving portion and the insertion groove, viewed from the front thereof, may be partially changed depending on the kinds of a supply voltage or a supply current.

The shape of the insertion groove viewed from the front may be changed such that an area of the plug-receiving portion is decreased as compared with a case that the plug-receiving portion has the substantially quadrangular shape viewed from the front.

The shape of the insertion groove viewed from the front may be changed differently depending on the kinds of the supply voltage or the supply current by cutting at least one side of the substantially quadrangular shape of the plug-receiving portion depending on the kinds of the supply voltage or the supply current, and forming the insertion groove along an outer periphery of the plug-receiving portion.

A portion of the insertion groove whose shape is changed depending on the kinds of the supply voltage or the supply current may be closer to the opposite side to the reference side than the reference side.

The shape of the insertion groove viewed from the front may be changed such that an area of the plug-receiving portion is increased as compared with a case that the plug-receiving portion has the substantially quadrangular shape viewed from the front.

The shape of the insertion groove viewed from the front may be changed by forming an extension groove extending from the insertion groove. In this case, the extension groove may be formed by extending a part of the insertion groove into the plug-receiving portion, and the extension groove may be provided closer to the opposite side to the reference side of the plug-receiving portion than the reference side.

Alternatively, the extension groove may be formed on the front surface of the outlet main body by outwardly extending a part of the insertion groove.

A shape of at least one of the plug-receiving portion and the insertion groove, viewed from the front thereof, may be partially changed depending on the kinds of a power supply circuit serving as a power supply source.

In this case, the shape of the insertion groove viewed from the front may be partially changed only when the power supply circuit is a safety extra low voltage (SELV) circuit.

The plug pins of the plug may include a ground pin, and the pin-inserting holes of the plug-receiving portion may include a ground pin inserting hole into which the ground pin of the plug is inserted. In this case, the ground pin inserting hole may be provided offset closer to the opposite side to the reference side.

In accordance with embodiments of the present invention, the outlet unit includes the plug-receiving portion having the substantially quadrangular-shape viewed from the front, the periphery of which is surrounded by the insertion groove. In the plug-receiving portion, two pin-inserting holes corresponding to the pin-receiving pieces for supplying the DC power are arranged along one side of the plug-receiving portion serving as the reference side and offset closer to the reference side of the plug-receiving portion. Accordingly, it is possible to easily recognize an orientation of the plug to be inserted into the outlet unit. In addition, since the orientation of the plug to be inserted into the outlet unit is restricted by the substantially quadrangular-shaped surrounding wall of the plug to be inserted into the insertion groove provided around the substantially quadrangular-shaped plug-receiving portion, it is possible to embody the DC outlet capable of easily performing position alignment, preventing the reverse insertion, and being conveniently used. Further, the plug-receiving portion has the substantially quadrangular-shape. Accordingly, even when two pin-inserting holes are arranged offset closer to the reference side, it is possible to obtain a sufficient insulation distance without reducing the distance between the pin-inserting holes, to thereby prevent the DC outlet from being scaled up.

### BRIEF DESCRIPTION OF THE DRAWINGS

The objects and features of the present invention will become apparent from the following description of embodiments, given in conjunction with the accompanying drawings, in which:

FIG. 1 is a schematic view showing an information rack employing a plug receptacle in accordance with a first embodiment of the present invention;

FIGS. 2A and 2B are a perspective view showing the outer appearances of the plug receptacle of the first embodiment and a front view of an outlet of the plug receptacle, respectively;

FIG. 3A shows front, side and bottom views of the plug receptacle and FIG. 3B is a plan view showing the internal structure of the plug receptacle;

FIG. 4 is a perspective view showing a plug to be connected to the plug receptacle;

FIGS. 5A to 5D are a front view, a side view, a top view and a partial cross sections view of the plug;

FIGS. 6A and 6B are a perspective view showing a connection relationship between the plug receptacle and the plug and a front view showing the state in which the plugs are connected to the plug receptacle;

FIGS. 7A to 7C are sectional view respectively showing a state before the plug is connected to the plug receptacle, a state of the plug being connected to the plug receptacle and a state in which the plug is connected to the plug receptacle;

FIG. 8A is a sectional view showing a state in which the plug is connected to the plug receptacle, FIGS. 8B and 8C are sectional views showing states the plug is being disconnected from the plug receptacle while a lock portion of the plug is pressed by the fingers, and FIG. 8D is a sectional view showing a state in which the plug is disconnected from the plug receptacle;

FIG. 9 is a front view of the plug receptacle which explains a case that the plug is reversely inserted into the plug receptacle;

FIG. 10 is a front view of an outlet unit of the plug receptacle, which shows the change of the shape of the outlet unit depending on the kinds of supply voltage;

FIG. 11 is a plan view of the plug receptacle in which the outlet units of various shapes are arranged;

FIG. 12 is a schematic diagram showing a structure of a DC power distribution system employing a plug receptacle in accordance with a second embodiment of the present invention;

FIG. 13 shows a perspective view of the plug receptacle of the second embodiment;

FIG. 14 is a front view showing the shape of the outlet unit of the plug receptacle depending on the kinds of power supply circuit;

FIG. 15 is a plan view showing the plug receptacle in which the outlet units of various shapes are arranged;

FIGS. 16A and 16B are front views showing modifications of the shape of the outlet unit;

FIG. 17 is a plan view of the plug receptacle in which the outlet units of various shapes are arranged;

FIGS. 18A to 18C are front views showing the shapes of the outlet unit of the plug receptacle depending on the kinds of supply current;

FIG. 19 shows a front view of an outlet unit as a comparative example;

FIGS. 20A and 20B are front views showing outlet units as another comparative example;

FIGS. 21A and 21B are front views of a plug and an outlet unit of a conventional plug receptacle, respectively;

FIGS. 22A and 22B show front views of an outlet unit of a plug receptacle as reference examples; and

FIGS. 23A and 23B show front views of an outlet unit of a plug receptacle as reference examples.

### DETAILED DESCRIPTION OF THE EMBODIMENTS

### First Embodiment

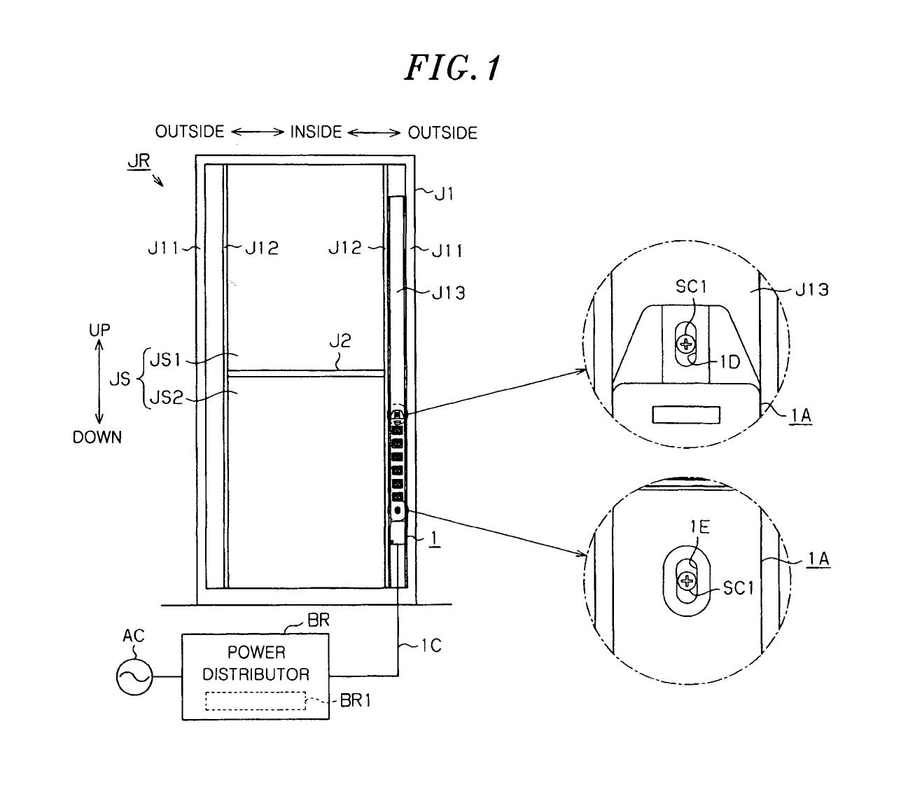

There will be described a plug receptacle in accordance with a first embodiment of the present invention which is embodied as an outlet attached to an information rack for accommodating a server device or the like with reference to FIGS. 1 to 11.

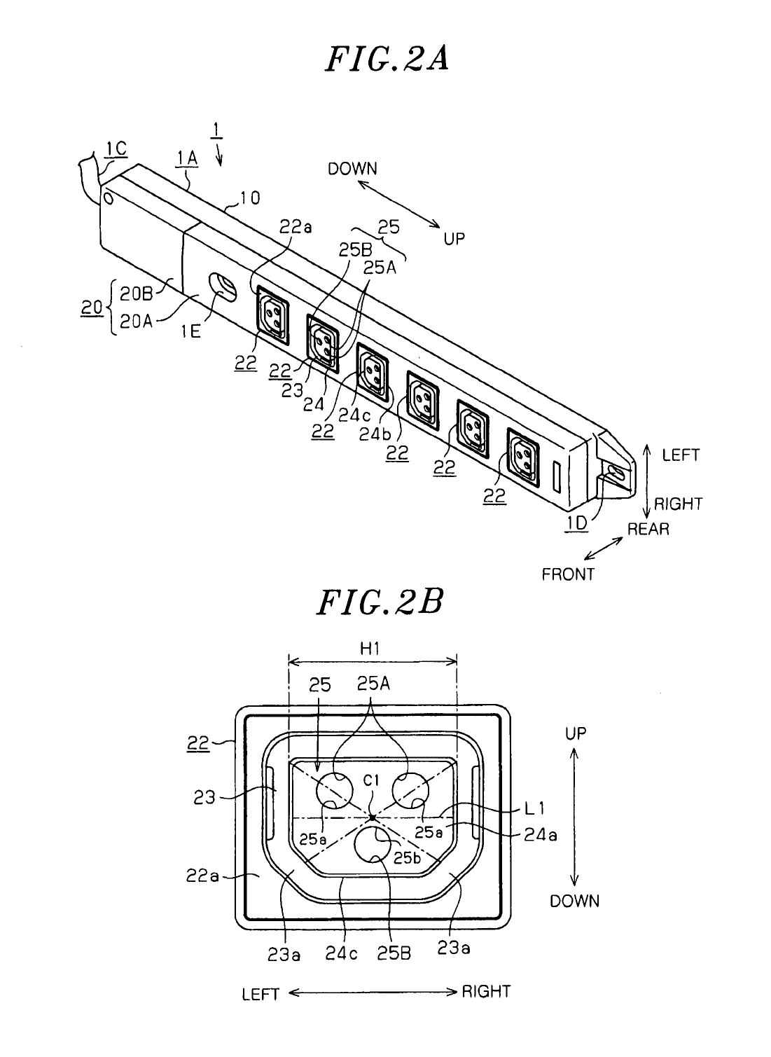

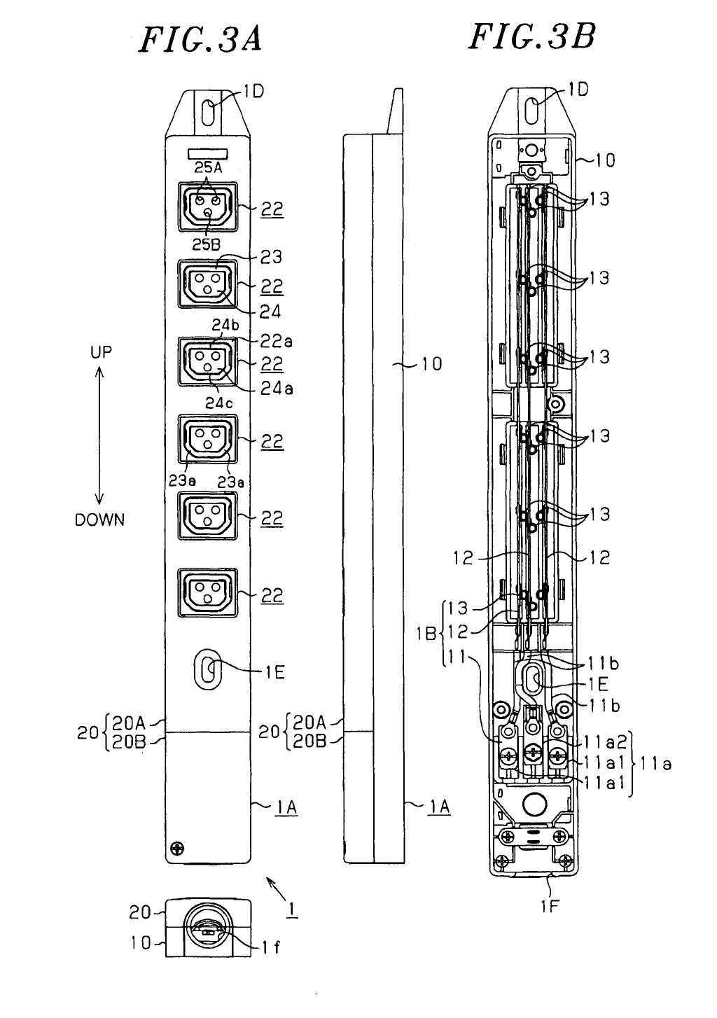

First of all, the relation between an information rack JR and a plug receptacle 1 and a power supply structure of the plug receptacle 1 will be described with reference to FIG. 1. In FIGS. 3 to 11, a cable 1C of the plug receptacle 1 is omitted, and a plug 2 is omitted in FIG. 2.

As shown in FIG. 1, the information rack JR is formed in a box shape by a frame body J1 forming an outer frame thereof. The information rack JR includes an accommodating section JS having an open front portion and serving as a space for accommodating a server device (not shown). Further, the information rack JR includes a partition member J2 for partitioning the accommodating section JS into an upper accommodating section JS1 and a lower accommodating section JS2 in an up-down direction.

The frame body J1 has an outer frame body J11 forming an outer part of the information rack JR and an inner frame body J12 defining the accommodating section JS, the inner frame body J12 being disposed inwardly of the outer frame body J11 while being spaced from the outer frame body J11 at a predetermined distance. A substantially flat plate-shaped outlet attachment member J13 extending in the up-down direction is provided between the outer frame body J11 and the inner frame body J12.

The plug receptacle 1 of this embodiment is attached to a lower portion of the outlet attachment member J13. To be specific, the plug receptacle 1 is attached to the information rack JR by inserting screws SC1 into upper and lower screw insertion through-holes 1D and 1E respectively formed at an upper and a lower portion of the plug receptacle 1 and then fixing the screws SC1 to the outlet attachment member J13.

AC power from an AC power supply AC as a commercial power supply is converted into DC power by an AC/DC converter BR1 of a power distributor BR, and the DC power thus obtained is supplied to the plug receptacle 1. Further, the power distributor BR and the plug receptacle 1 are connected to each other by the cable 1C. Accordingly, the DC power is supplied through the cable 1C to a power feeding member 1B (see FIG. 3B) provided inside the plug receptacle 1. Moreover, the DC power is supplied to a server device by connecting a plug (not shown) of the server device to the plug receptacle 1. The cable 1C has two electrode wires and a single ground wire.

Hereinafter, the configuration of the plug receptacle 1 will be explained with reference to FIGS. 2 and 3.

As depicted in FIG. 2A, the plug receptacle 1 includes: a substantially rectangular parallelepiped-shaped housing 1A forming an outer frame thereof; the power supply member 1B (see FIG. 3B) accommodated in the housing 1A; and the cable 1C for supplying DC power to the power supply member 1B. In the following description, a direction in which the plug 2 is inserted into the plug receptacle 1 is defined as a front-rear direction; a longitudinal direction of the housing 1A is defined as an up-down direction; and a width direction of the housing 1A is defined as a left-right direction. Further, a side where the plug 2 is positioned is defined as a front side, and a side where the plug receptacle 1 is positioned is defined as a rear side. The up-down direction and the left-right direction are perpendicular to each other.

The housing 1A includes: a substantially box-shaped body 10 having an open front portion and formed by injection molding using a resin material; and a substantially box-shaped cover 20 having an open rear portion and formed by injection molding using a resin material. Moreover, an inner space defined by the body 10 and the cover 20 accommodates therein the power supply member 1B adapted to be connected to the plug 2 to supply DC power thereto.

The cover 20 has a first cover 20A provided with six outlet units 22 arranged along the up-down direction, and a second cover 20B for covering a cable connection portion 11 (see FIG. 3B) from the front side, the cable connection portion 11 being connected to the cable 1C. The DC power plugs 2 are, e.g., detachably connected to the outlet units 22.

As illustrated in FIG. 2B, the outlet unit 22 has an insertion groove 23 recessed rearward from a front surface 22a of the outlet unit 22. The insertion groove 23 has a shape in which lower right and left corners of a substantially quadrangular shape viewed from the front side are cut. To be specific, the lower right and left corners of the insertion groove 23 are cut to have inclined sections 23a. A portion surrounded by the insertion groove 23 serves as a plug-receiving portion 24 having a front surface 24a positioned on the same plane as the front surface 22a in the front-rear direction. An outer periphery of the plug-receiving portion 24 has a shape in which lower right and left corners of a substantially quadrangular shape viewed from the front side are cut in accordance with the shape of the insertion groove 23. Moreover, three pin insertion holes 25 are formed at the plug-receiving portion 24. These pin insertion holes 25 are circular through-holes as viewed from the front.

The pin insertion holes 25 include two electrode-pin insertion holes 25A and a single ground-pin insertion hole 25B. The electrode-pin insertion holes 25A are arranged along a reference side 24b corresponding to one side (extending in the left-right direction) of the outer periphery of the plug-receiving portion 24, i.e., the upper side of the plug-receiving portion 24. The ground-pin insertion hole 25B is disposed offset closer to a side opposite to the reference side 24b than to the reference side 24b, compared to those of the electrode-pin insertion holes 25A. In other words, the position of the ground-pin insertion hole 25B is lower than that of the electrode-pin insertion holes 25A.

To be more specific, the electrode-pin insertion holes 25A are arranged offset closer to the reference side 24b than to the side 24c of the plug-receiving portion 24. That is, the electrode-pin insertion holes 25A are disposed above the center C1 (i.e., an intersection point of diagonal lines (dash-dotted lines) of the plug-receiving portion 24 in the up-down direction. Further, the electrode-pin insertion holes 25A are located at left and right sides of the center C1. Especially, lower ends 25a of the electrode-pin insertion holes 25A which face the side 24c are positioned closer to the reference side 24b than to the side 24c, i.e., above the central line L1 (dashed double-dotted line) passing through the center C1.

The ground-pin insertion hole 25B is offset downward from the center C1. Further, the ground-pin insertion hole 25B is located at the central position between the two electrode-pin insertion holes 25A in the left-right direction. In other words, the ground-pin insertion hole 25B and the center C1 are positioned corresponding to each other in the up-down direction. Especially, an upper end 25b of the ground-pin insertion hole 25B is positioned closer to the side 24c than to the reference side 24b, i.e., below the central line L1.

The inclined sections 23a are provided only below the straight line L1, so that it is possible to obtain a sufficient distance between the inclined sections 23a and the electrode-pin insertion holes 25A compared to a case that the inclined sections are provided above the central line L1.

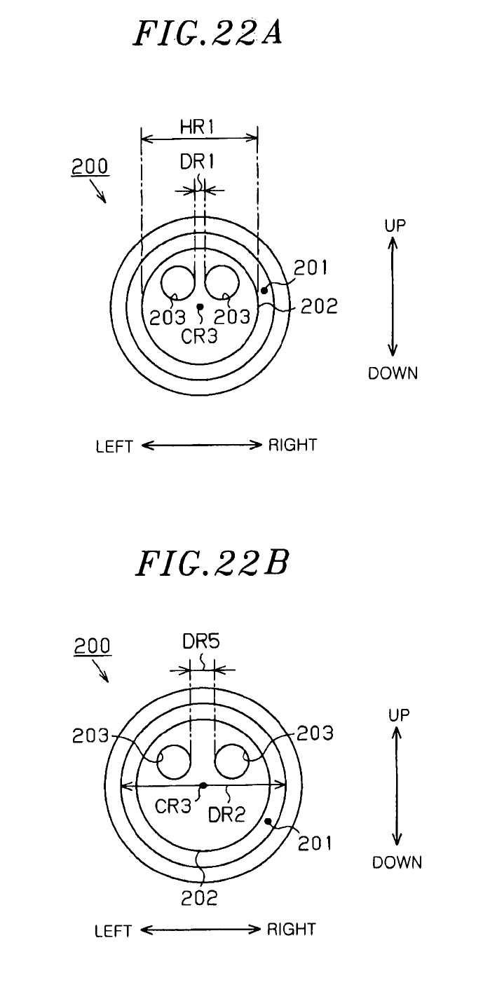

The upper part of the plug-receiving portion 24 has substantially the same horizontal width H1 (see FIG. 2B). Thus, even when the two electrode-pin insertion holes 25A are offset upward from the center C1, scaling up of the outlet unit 22 is not required. This can suppress scaling up of an outlet unit 200 shown in FIG. 22B.

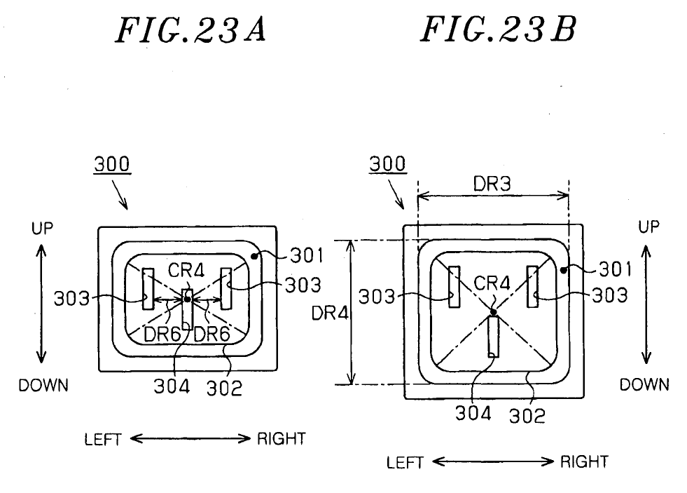

In addition, as illustrated in FIG. 23A, a single ground-pin insertion hole 304 is formed at a lower portion of a plug-receiving portion 302 of an outlet unit 300. The ground-pin insertion hole 304 has a vertically elongated rectangular shape and is located at the horizontal central position between two electrode-pin insertion holes 303.

In order to obtain the ground-pin insertion hole 304 having the same area as that of the ground-pin insertion hole 25B of this embodiment, an upper portion of the ground-pin insertion hole 304 is extended upward from the center CR4. Hence, the electrode-pin insertion holes 303 and the ground-pin insertion hole 304 are partially positioned at the same horizontal level. This decreases a minimum horizontal distance DR6 between the ground-pin insertion hole 304 and each of the electrode-pin insertion holes 303. That is, electrode pins and a ground pin (all not shown) of the plug are arranged adjacent to each other.

Hence, the plug-receiving portion 302 can be scaled up by increasing outer diameters DR3 and DR4 of the insertion groove 301, as shown in FIG. 23B. In this configuration, the distance DR6 can increase compared to that in the outlet unit 300 shown in FIG. 23A.

In the above configuration of FIG. 23B, the outlet unit 300 is scaled up.

However, in this embodiment, the electrode-pin insertion holes 25A are formed in a circular shape, so that a vertical width thereof can decrease compared to that of the electrode-pin insertion hole 303. Thus, the electrode-pin insertion holes 25A can be formed above the center C1 of the plug-receiving portion 24 without scaling up the outlet unit 22.

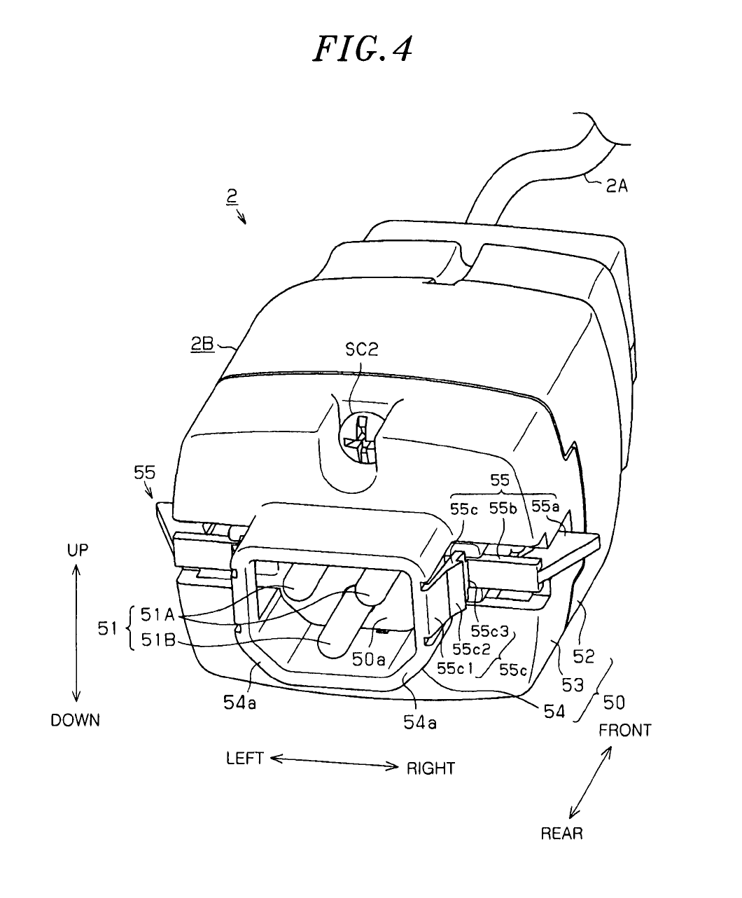

Further, the ground-pin insertion hole 25B is formed in a circular shape, so that a vertical width thereof can decrease compared to that of the ground-pin insertion hole 304. For that reason, the ground-pin insertion hole 25B can be formed below the center C1 of the plug-receiving portion without scaling up of the outlet unit 22. Due to the positional relation between the electrode-pin insertion holes 25A and the ground-pin insertion hole 25B, the minimum distance between each of the electrode-pin insertion holes 25A and the ground-pin insertion hole 25B can increase compared to the distance DR6 (see FIG. 23A) between the ground-pin insertion hole 304 and each of the electrode-pin insertion holes 303. This allows the minimum distance between each of the electrode pins 51A and the ground pin 51B (see FIG. 4) to increase compared to that in a plug corresponding to the outlet unit 300.

As illustrated in FIG. 3A, the outlet unit 22 is disposed such that the electrode-pin insertion holes 25A are placed at an upper portion and the ground-pin insertion hole 25B is placed at a lower portion. Moreover, the electrode-pin insertion holes 25A and the ground-pin insertion hole 25B of all the outlet units 22 are located at the same level in the left-right direction.

Formed at the lower end portion of the housing 1A is a cable insertion through-hole 1F which penetrates the housing 1A in the up-down direction and allows the cable 1C (see FIG. 1) to extend therethrough.

As can be seen from FIG. 3B, the power supply member 1B includes: a cable connection unit 11 connected to the cable 1C; a pin-receiving piece connection portion 12 connected to the cable connection unit 11; and a pin-receiving piece 13 connected to the pin-receiving piece connection portion 12.

The cable connection unit 11 has a first connection unit 11a connected to the cable 1C and a second connection unit 11b having three wires for connecting the first connection unit 11a and the pin-receiving piece connection portion 12. The first connection unit 11a has two electrode connection portions 11a1 and a ground connection portion 11a2 provided between the two electrode connection portions 11a1.

The pin-receiving piece connection portion 12 includes three flat copper plates spaced from each other in the left-right direction and extending in the up-down direction. The lower end portion of the pin-receiving piece connection portion 12 is connected to the second connection unit 11b.

The pin-receiving pieces 13 are arranged to correspond to the electrode-pin insertion holes 25A and the ground-pin insertion hole 25B of the outlet unit 22, and are connected to the pin-receiving piece connection portion 12. To be specific, six pin-receiving pieces 13 spaced from each other at a predetermined gap in the up-down direction are connected to the pin-receiving piece connection portion 12.

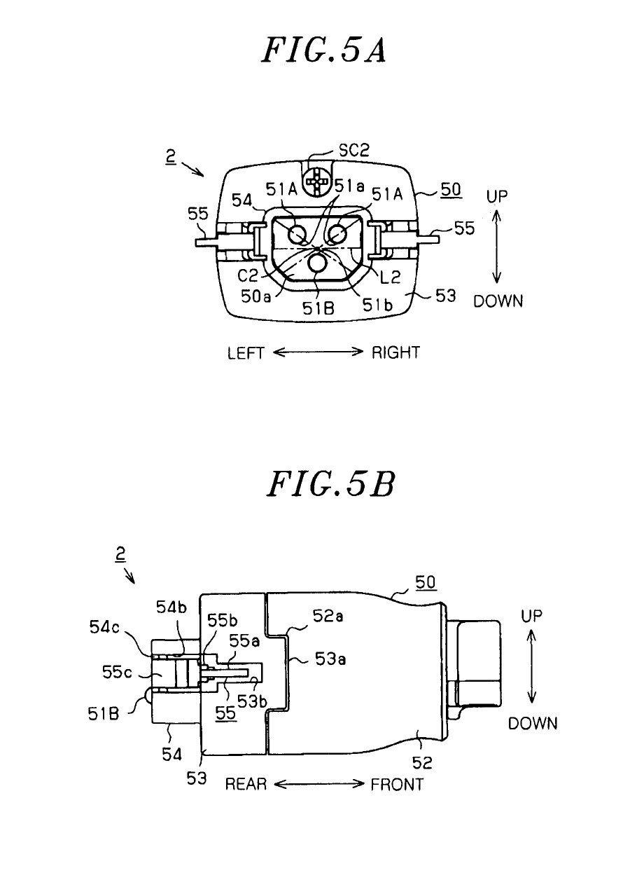

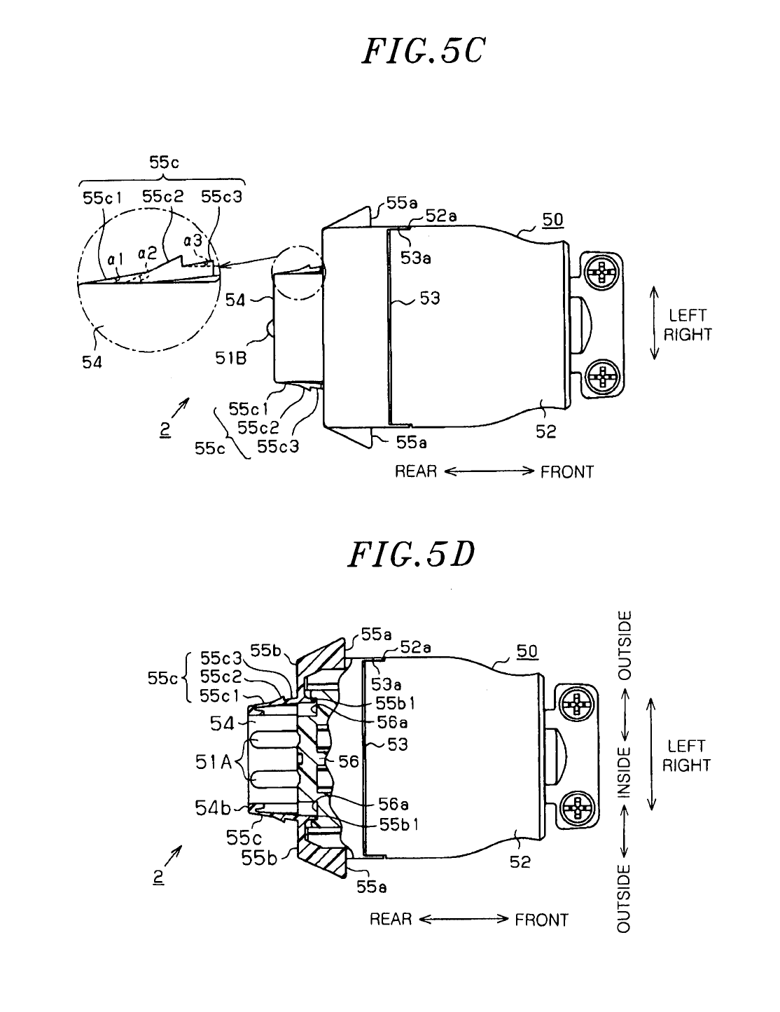

Hereinafter, the configuration of the plug 2 will be described with reference to FIGS. 4 and 5.

As shown in FIG. 4, the plug 2 includes a cable 2A and a plug main body 2B connected to the cable 2A. The plug main body 2B has a case formed by injection molding using a resin material, a connection member (not shown) accommodated in the case 50 and supplied with power through the cable 2A, and plug pins 51 connected to the connection member.

The case 50 includes a first case 52, a second case 53 and a surrounding wall 54 arranged in that order from the front side toward the rear side.

The first case 52 accommodates therein a part of the cable 2A and the connection member. The cable 2A extends frontward from a front end surface of the first case 52.

The second case 53 is fixed to the first case 52 by screws SC2 and accommodates therein front portions of the plug pins 51.

The surrounding wall 54 extends rearward from a rear end surface of the second case 53. The second case 53 and the surrounding wall 54 are formed as a unit. The surrounding wall 54 surrounds the plug pins 51 from the outer side thereof. To be specific, the surrounding wall 54 has a shape in which lower right and left corners of a substantially quadrangular shape viewed from the rear side are cut. To be more specific, the lower right and left corners of the surrounding wall 54 are cut to have inclined sections 54a. Locking units 55 to be engaged with the outlet unit 22 are provided at both side surfaces of the second case 53.

Each of the locking units 55 includes a pressing portion 55a, a connection portion 55b and an engagement portion 55c arranged in that order from the front side toward the rear side. The locking units 55 are connected to the surrounding wall 54. In other words, the surrounding wall 54 and the locking units 55 are formed in a single member.

As shown in FIG. 5A, the plug pins 51 include: two electrode pins 51A arranged along a side (extending in the left-right direction) of a surface 50a of the second case 53 which faces the outlet unit 22 (see FIG. 2) of the plug receptacle 1; and a single ground pin 51B positioned below the electrode pins 51A. The electrode pins 51A do not protrude beyond the leading end of the surrounding wall 54. The ground pin 51B protrudes slightly beyond the leading end of the surrounding wall 54.

The electrode pins 51A are positioned above the center C2 (i.e., an intersection point of diagonal lines (dashed dotted lines) of the surrounding wall 54. Further, the electrode pins 51A are formed at both sides of the center C2 in the left-right direction. Especially, lower ends 51a of the electrode pins 51A are positioned above the central line L2 (dashed double-dotted line) passing through the center C1.

The ground pin 51B is provided below the center C2. Further, the ground pin 51B is located at the central position (in the left-right direction) between the two electrode pins 51A (i.e., at the same level as the center C2 in the left-right direction). Especially, an upper end 51b of the ground pin 51B is positioned below the central line L2.

As shown in FIG. 5B, recesses 52a depressed frontward are formed at rear end portions of both side surfaces of the first case 52, and protrusion 53a to be engaged with the recesses 52a are formed at front end portions of both side surfaces of the second case 53. The locking units 55 and the protrusions 53a are located at the same height level.

Cutoff portions 53b for accommodating the pressing portions 55a and the connection portions 55b are provided at both side surfaces of the second case 53. A vertical width of the cutoff portions 53b is set to be greater than those of the pressing portions 55a and the connection portions 55b.

Cutoff portions 54b for accommodating the engagement portions 55c are provided at both side surfaces of the surrounding wall 54. Further, locking unit connection portions 54c to be connected to the engagement portions 55c are disposed at rear end portions of both side surfaces of the surrounding wall 54.

A vertical width of the connection portions 55b is set to be greater than that of the pressing portions 55a. Moreover, a vertical width of the engagement portions 55c is set to be greater than that of the connection portions 55b.

As can be seen from FIG. 5C, the pressing portions 55a protrude from both side surfaces of the second case 53. To be specific, each of the pressing portions 55a has an inclined outer surface which is gradually separated from the corresponding side surface of the second case 53.

Each of the engagement portions 55c includes a first inclined section 55c1, a second inclined section 55c2 and a third inclined section 55c3 arranged in that order from the rear side toward the front side. The first inclined sections 55c1 are connected to the locking unit connection portions 54c. Further, the first inclined sections 55c1 are inclined toward the front side to be gradually separated from both side surfaces of the surrounding wall 54.

The second inclined sections 55c2 are connected to front end portions of the first inclined sections 55c1. In addition, the second inclined sections 55c2 are inclined toward the front side so as to be gradually widened outward. An inclined angle α2 of the second inclined section 55c2 is different from an inclined angle α1 of the first inclined section 55c1. To be specific, the inclined angle α2 is set to be greater than the inclined angle α1.

The third inclined sections 55c3 are connected to front end portions of the second inclined sections 55c2 and both sides of the connection portions 55b (see FIG. 5B). Moreover, the third inclined sections 55c3 are inclined toward the front side so as to be gradually widened outward. An inclined angle α3 of the third inclined section 55c3 is set to be equal to the inclined angle α1.

As illustrated in FIG. 5D, a width of the engagement portions 55c gradually decreases from the second inclined sections 55c2 toward the first inclined sections 55c1, i.e., from the front side toward the rear side.

The plug 2 has a pin supporting portion 56 for supporting the plug pins 51. The pin supporting portion 56 has recesses 56a depressed rearward at the left and right sides of the plug pins 51. The recesses 56a accommodate therein protrusions 55b1 formed at the connection portions 55b. Specifically, the protrusions 55b1 contact with a right and a left outer wall defining the recesses 56a. This prevents the locking units 55 from being excessively deformed outward in the left-right direction.

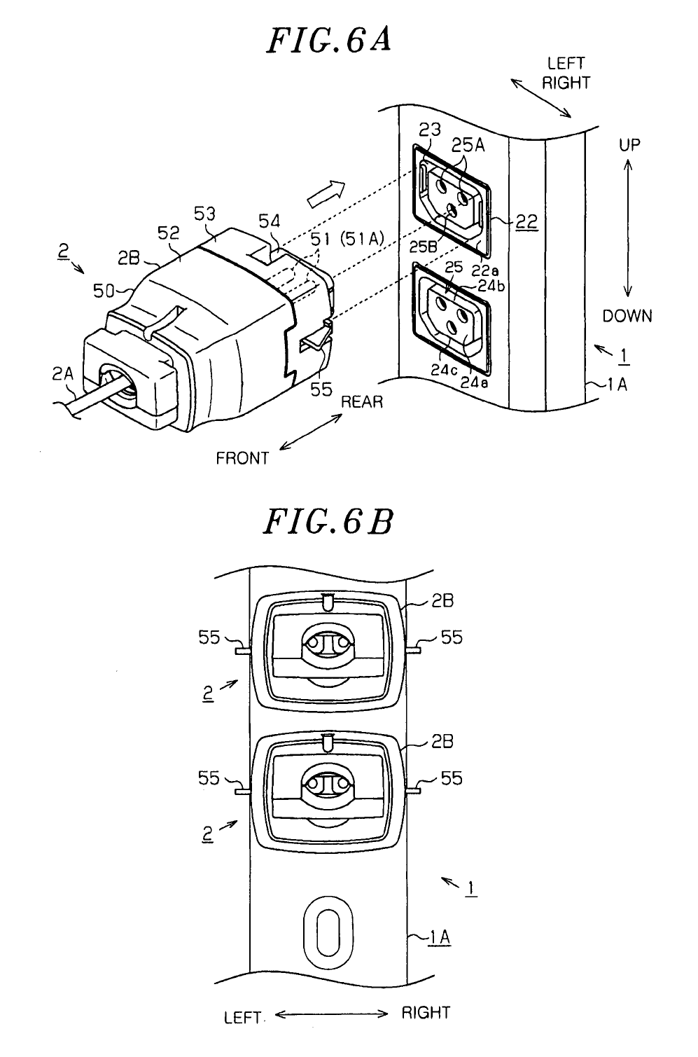

Hereinafter, a configuration when the plug 2 is inserted into the plug receptacle 1 and a configuration when the plug 2 is separated from the plug receptacle 1 will be described with reference to FIGS. 6A to 8D.

As shown in FIG. 6A, when the plug 1 is inserted into the plug receptacle 1, the surrounding wall 54 of the plug main body 2B is inserted into the insertion groove 23 of the outlet unit 22 so that the plug pins 51 are inserted into the pin insertion holes 25.

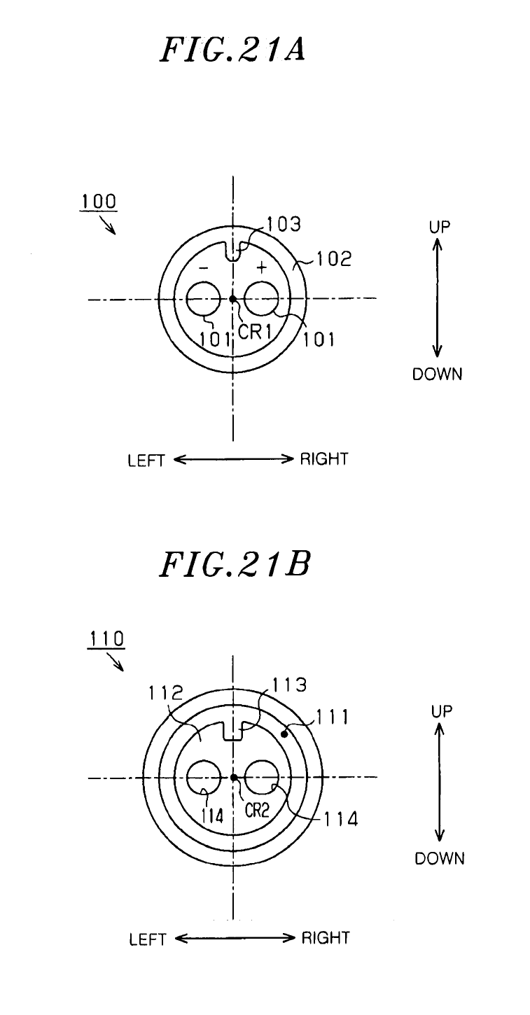

In a conventional outlet unit 110 standardized by IEC standard, an insertion groove 111 and a surrounding wall 102 are formed in a ring shape, as depicted in FIGS. 21A and 21B. Therefore, the surrounding wall 102 of a plug 100 is inserted into the insertion groove 111 around the circumferential direction of 360°.

However, in this embodiment, the insertion groove 23 and the surrounding wall 54 have a shape obtained by cutting the lower right and left corners of the substantially quadrangular shape viewed from the front side. Hence, the orientation of the surrounding wall 54 to be inserted into the insertion groove 23 is limited to one orientation. Since the orientation of the plug 2 to be inserted into the plug receptacle 1 is limited, an operator can easily determine the orientation of the plug 2 to be inserted into the plug receptacle 1. As a consequence, the operator can insert the plug 2 into the plug receptacle 1 with ease while avoiding reverse insertion.

As depicted in FIG. 6B, a horizontal width of the plug main body 2B of the plug 2 is substantially equal to that of the housing 1A of the plug receptacle 1. To be specific, the pressing portions 55a of the locking units 55 of the plug 2 protrude from the housing 1A slightly outward in the left-right direction.

The locking units 55 are provided at the left and right sides of the plug 2, so that a distance between the plugs 1 adjacent to each other in the up-down direction can decrease compared to a case that the locking units are provided at the upper and lower sides of the plug 2. This suppresses scaling up of the plug receptacle 1 in the up-down direction.

To be specific, when the locking units are provided at the upper and the lower sides of the plug, the locking units protrude upward and downward from the plug. Hence, spaces for accommodating the two locking units are required between the plugs adjacent to each other in the up-down direction. In addition, spaces for allowing an operator to manipulate the locking units with the fingers are required, so that spaces between the plugs adjacent to each other in the up-down direction should be increased. This leads to scaling up of the plug receptacle in the up-down direction.

In this embodiment, the locking units 55 are provided at the left and right sides of the plug. Thus, the spaces for accommodating the locking units 55 and the spaces for allowing an operator to insert the fingers can be omitted between the plugs 2 adjacent to each other in the up-down direction. Accordingly, the plug receptacle 1 needs not to be scaled up.

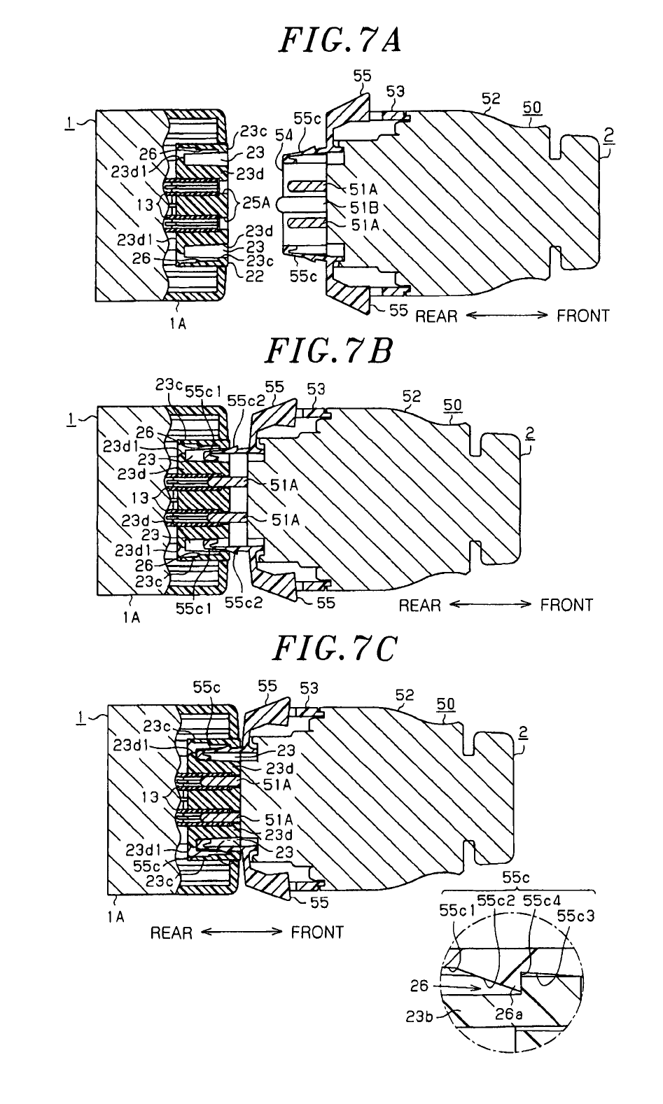

FIGS. 7A to 7C describe processes for inserting the plug 2 into the plug receptacle 1. The plug 2 is separated from the plug receptacle 1 (FIG. 7A). By engaging the locking portions 55 of the plug 2 with the insertion groove of the plug receptacle 1 (FIG. 7B), the plug 2 is connected to the plug receptacle 1 (FIG. 7C). The detailed description thereof will be described hereinafter.

As can be seen from FIG. 7A, the insertion groove 23 of the outlet unit 22 is provided with surrounding wall holding portions 26. To be specific, the insertion groove is formed as a recessed space defined by an outer wall 23c and an inner wall 23d of the outlet unit 22, the inner wall 23d being connected to the plug-receiving portions 24. The surrounding wall holding portions 26 are formed in a stepped shape which allows the engagement portions 55c of the plug 2 to be engaged with the outer wall 23c. Further, contact portions 23d1 protrude from a rear end portion of the inner wall 23d toward the outer wall 23c so as to contact with the surrounding wall 54 of the plug 2.

As shown in FIG. 7B, the electrode pins 51A of the plug 2 are inserted into the electrode-pin insertion holes 25A while the plug 2 is being inserted into the plug receptacle 1. Although it is not shown, the ground pin 51B is inserted into the ground-pin insertion hole 25B.

Moreover, a part of the surrounding wall 54 is inserted into the insertion groove 23. At this time, the third inclined sections 55c3 are inserted into the insertion groove 23, and the second inclined sections 55c2 contact with the outer wall 23c. As a consequence, the engagement portions 55c are elastically deformed inward in the left-right direction.

As shown in FIG. 7C, in the state that the insertion of the plug 2 into the plug receptacle 1 is completed, the electrode pins 51A of the plug 2 are inserted into and held by the pin-receiving pieces 13 of the plug receptacle 1. Therefore, the plug receptacle 1 and the plug 2 are electrically connected to each other. Although it is not shown, the ground pin 51B is also connected to the plug receptacle 1.

When the second inclined sections 55c2 are engaged with the surrounding wall holding portions 26, the engagement portions 55c are restored outward in the left-right direction by restoration force. Thus, front surfaces 55c4 of the second inclined sections 55c2 face facing surfaces 26a of the surrounding wall holding portions 26 in the front-back direction. Hence, when the plug 2 moves forward, its movement is restricted by the contact between the surfaces 55c4 and the facing surfaces 26a.

Further, the rear end surface of the surrounding wall 54 contacts with the contact portions 23d1 of the inner wall 23d, so that the plug 2 is prevented from moving backward beyond the contact portions 23d1. That is, the forward/backward movement of the plug 2 with respect to the plug receptacle 1 is restricted.

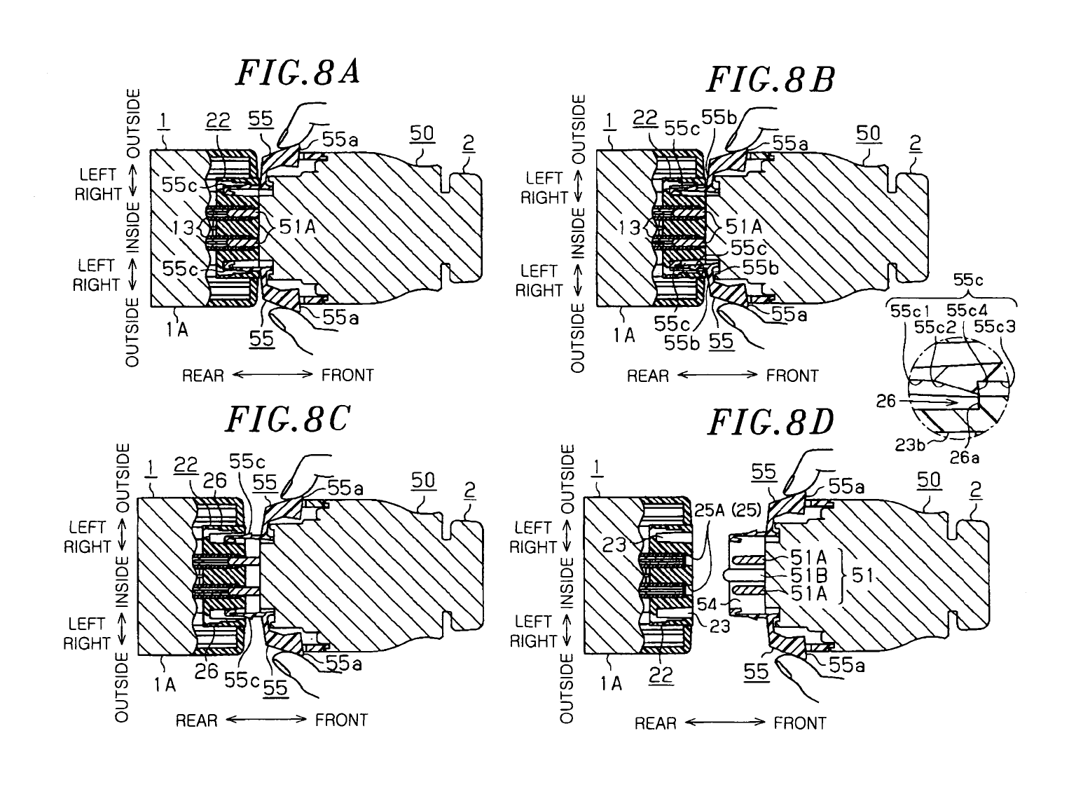

FIGS. 8A to 8D show processes for separating the plug 2 from the plug receptacle 1. The plug 2 is in a state of being inserted into the plug receptacle 1 (FIG. 8A). An operator grips the locking units 55 of the plug 2 to release the engagement between the locking units 55 and the insertion groove 23 (FIG. 8B) and then pulls the plug forward (FIG. 8C). Accordingly, the plug 2 is separated from the plug receptacle 1 (FIG. 8D). The detailed description thereof will be described hereinafter.

In order to separate the plug 2 from the plug receptacle 1, an operator grips the pressing portions 55a of the plug 2 as shown in FIG. 8A, and then presses the pressing portions 55a inward as illustrated in FIG. 8B. Accordingly, the pressing portions 55a and the connection portions 55b are elastically deformed, and this allows inward elastic deformation of the engagement portions 55c. In that state, the surfaces 55c4 of the second inclined sections 55c2 of the engagement portions 55c are positioned inwardly of the facing surfaces of the insertion groove 23. In other words, the surfaces 55c4 and the facing surfaces are not overlapped with each other in the front-back direction. Next, the operator pulls the plug 2 forward as depicted in FIG. 8C, so that the engagement portions 55c are separated from the surrounding wall holding portions 26. Thereafter, as can be seen from FIG. 8D, the operator pulls the plug 2 further forward so as to separate the surrounding wall 54 and the plug pins 51 from the insertion groove 23 and the pin insertion holes 25.

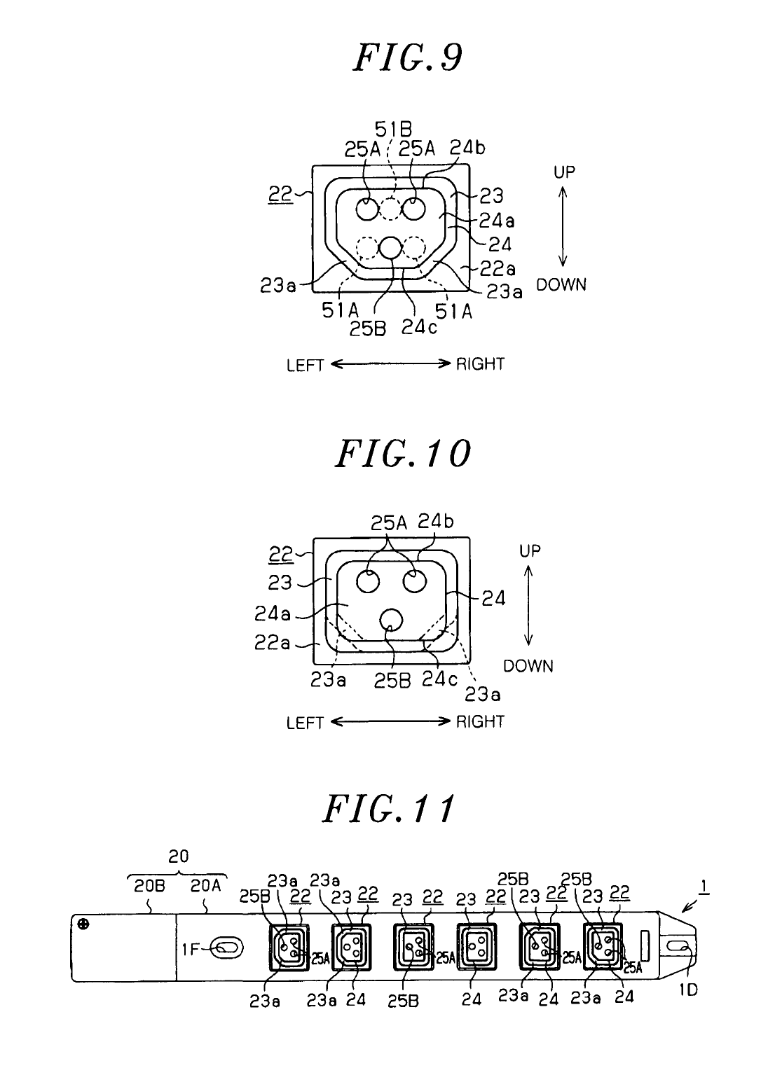

Hereinafter, reverse insertion of the plug 2 into the plug receptacle 1 will be described with reference to FIG. 9.

As illustrated in FIG. 9, when the plug 2 is reversely inserted into the plug receptacle 1, the electrode pins 51A of the plug 2 are located below the center C1 of the plug-receiving portion 24 in the up-down direction, and the ground pin 51B is placed above the center C1 in the up-down direction. Hence, the electrode pins 51A and the ground pin 51B contact with the front surface 24a of the plug-receiving portion 24, and the plug 2 cannot be inserted into the plug receptacle 1.

In that state, the electrode-pin insertion holes 25A and the electrode pins 51A are misaligned with each other in the up-down direction, and the ground-pin insertion hole 25B and the ground pin 51B are misaligned with each other in the up-down direction. Accordingly, the reverse insertion of the plug pins 51 into the pin insertion holes 25 can be reliably prevented.

Hereinafter, shapes of the outlet unit 22 depending on the kinds of supply voltages will be described with reference to FIG. 10.

There is a plurality of electric devices requiring supply voltages, e.g., 6, 12, 24, 48 V, and the electric devices are operated when being connected with the plug receptacle 1. In this embodiment, the insertion groove 23 and the plug-receiving portion 24 have a substantially quadrangular shape viewed from the front side, and at least one corner of the substantially quadrangular shape is cut depending on the kinds of supply voltages, which allows the outlet unit 22 to be identified. To be specific, at least one corner of the insertion groove 23 is cut to have an inclined section 23a depending on the supply voltages of 6V, 12V, 24V and 48V. Further, corners of the plug-receiving portion 24 corresponding to the inclined sections 23a are cut to have inclined sections.

The surrounding wall 54 of the plug 2 has an inclined section of inclined sections in accordance with the shape of the insertion groove 23, which allows the plug 2 to be identified depending on the kinds of supply voltages. The plug 2 cannot be inserted into the plug receptacle 1 unless the shape of the surrounding wall 54 of the plug 2 is identical with that of the insertion groove 23 of the outlet unit 22. Thus, the plug 2 and the plug receptacle 22 which are used for different supply voltages cannot be connected to each other.

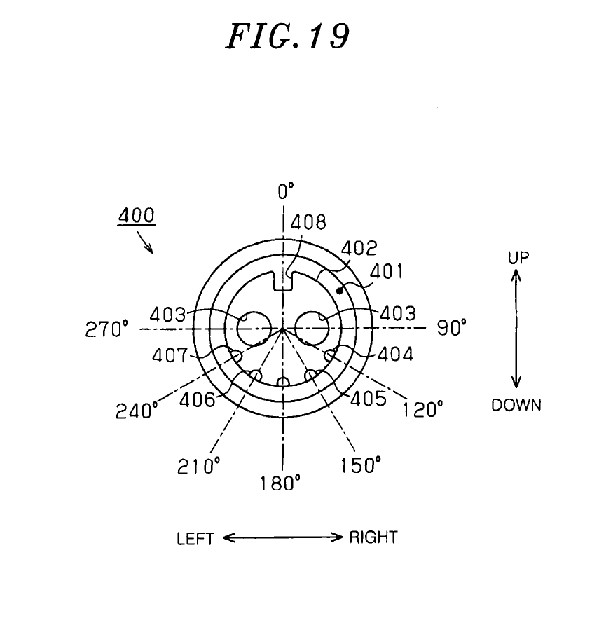

In the outlet unit 400 standardized by IEC standard, four cutoff grooves 404 to 407 are formed depending on the kinds of supply voltages, as illustrated in FIG. 19. To be specific, the outlet unit 400 has an insertion groove 401 formed in a round ring shape viewed from the front side. A plug-receiving portion 402 surrounded by the insertion groove 401 has pin insertion holes 403 into which plug pins (not shown) of the plug are inserted. The cutoff grooves 404 to 407 recessed inward from the insertion groove 401 are formed at a lower portion of an outer periphery of the plug-receiving portion 402. Moreover, a cutoff groove 408 for preventing reverse insertion of the plug is formed at an upper portion of the outer periphery of the plug-receiving portion 402.

The cutoff grooves 404 to 407 respectively correspond to the supply voltages of 6V, 12V, 24V and 48V, and are spaced from the cutoff groove 408 at angles of 120°, 150°, 210° and 240° in the clockwise direction. Further, the plug has an identifying rib corresponding to the cutoff groves 404 to 407. By inserting the identifying rib into the corresponding one of the cutoff grooves 404 to 407, the plug for the same supply voltage as that of the outlet unit 400 can be inserted into the corresponding outlet unit 400.

Since, however, the cutoff grooves 404 to 407 are formed near the pin insertion holes 403, the strength of the plug-receiving portion 402 decreases. Moreover, the identifying rib is formed at the inner surface of the surrounding wall, so that it is difficult for an operator to check the position of the identifying rib from the front side of the plug. Therefore, in order to insert the plug into the outlet unit 400, the operator should check the position of the identifying rib from the rear side of the plug and align the identifying rib of the plug with the corresponding one of the cutoff portions 404 to 407 of the outlet unit 400. For that reason, the operation of inserting the plug into the outlet unit 400 becomes complicated.

In this embodiment, the inclined sections 23a are provided at the lower corners of the insertion groove 23, so that it is possible to obtain a sufficient distance between the inclined sections 23a and the pin insertion holes 25 compared to the configuration of the outlet unit 400. This can suppress decrease in strength of the plug-receiving portion 24 compared to the configuration of the outlet unit 400.

Besides, the shape of the surrounding wall 54 of the plug 2 is changed depending on the kinds of supply voltages, so that the alignment position between the plug 2 and the outlet unit 22 can be visually checked from the front side of the plug 2. As a consequence, the plug 2 can be easily inserted into the outlet unit 22.

As shown in FIG. 11, the outlet units 22 having the various shapes in accordance with the kinds of supply voltages are arranged on the plug receptacle 1. Accordingly, the plug receptacle 1 can be used for various supply voltages. The combination of the outlet units 22 may vary without being limited to that shown in FIG. 11.

The plug receptacle 1 of this embodiment can provide the following effects.

(1) In this embodiment, the insertion groove 23 of the outlet unit 22 has a substantially quadrangular shape, so that the orientation of the plug 2 to be inserted into the surrounding wall 54 is limited compared to the case that the insertion grooves 111 and 201 have a round ring shape as shown in FIGS. 21B, 22A and 22B. This enables an operator to easily recognize the insertion orientation of the plug 2 into the outlet unit 22, which is convenient in use. Accordingly, the operator can easily insert the plug 2 into the plug receptacle 1 while avoiding reverse insertion.

Moreover, the electrode-pin insertion holes 25A are provided above the center C1, and the ground-pin insertion hole 25B is provided below the center C1. Thus, the reverse insertion of the plug 2 into the plug receptacle 1 can be prevented without forming a reverse insertion preventing structure at the insertion groove 23 and the surrounding wall 54. Accordingly, scaling up of the plug receptacle 1 can be suppressed compared to the case that the plug receptacle is provided with a reverse insertion preventing structure.

In addition, the electrode-pin insertion holes 25A and the ground-pin insertion hole 25B have a circular shape, so that the minimum distance between the ground-pin insertion hole 25B and each of the electrode-pin insertion holes 25A can increase compared to the case that the electrode-pin insertion holes 25A and the ground-pin insertion hole 25B have a rectangular shape as shown in FIGS. 23A and 23B. Hence, insulation strength can be improved without scaling up the outlet unit 22 compared to the case that the electrode-pin insertion holes 25A and the ground-pin insertion hole 25B are formed in a rectangular shape.

Besides, since the ground-pin insertion hole 25B is formed at the outlet unit 22, the plug receptacle 1 can correspond to the plug 2 having the ground pin 51B as well as the plug 2 having no ground pin.

(2) In this embodiment, the ground-pin insertion hole 25B is located below the electrode-pin insertion holes 25A in the up-down direction, so that the minimum distance between the electrode-pin insertion holes 25A and the ground-pin insertion hole 25B of the plug-receiving portion 24 can increase compared to the case that the electrode-pin insertion holes and the ground-pin insertion hole are located at the substantially same height level. Accordingly, it is possible to increase an insulation distance between the electrode-pin insertion holes 25A and the ground-pin insertion hole 25B while suppressing scaling up of the plug receptacle 1, and also possible to suppress decrease in strength of the plug-receiving portion 24.

(3) In this embodiment, the lower ends 25a of the electrode-pin insertion holes 25A are located above the center C1 in the up-down direction. Therefore, even if the plug 2 is reversely inserted into the plug receptacle 1, the electrode pins 51A are not inserted into the electrode-pin insertion holes 25A. As a result, the reverse insertion can be reliably prevented. Further, the minimum distance between the electrode-pin insertion holes 25A and the ground-pin insertion hole 25B can increase.

Furthermore, the ground-pin insertion hole 25B is positioned corresponding to the center C1 in the up-down direction, and the upper end 25b of the ground-pin insertion hole 25B is located below the center C1 in the up-down direction. Therefore, the minimum distance between the electrode-pin insertion holes 25A and the ground-pin insertion hole 25B can increase compared to a case that the position of the ground-pin insertion hole is offset to the right or lest side from the center C1 in the left-right direction. Besides, the minimum distance between the electrode-pin insertion holes 25A and the ground-pin insertion hole 25B can increase compared to a case that the upper end 25b of the ground-pin insertion hole is positioned above the center C1 in the up-down direction.

(4) In this embodiment, the inclined sections 23a are formed at corners of the insertion groove 23 and, accordingly, the shape of the surrounding wall 54 is changed in accordance with the shape of the insertion groove 23. The shapes of the surrounding wall 54 and the insertion groove 34 are changed depending on the kinds of supply voltages, so that the insertion of the plug 2 into the plug receptacle 1 which is used for a different supply voltage can be prevented.

Moreover, the operator can visually recognize the insertion orientation of the plug 2 into the plug receptacle 1 from the shape of the surrounding wall 54. Hence, the operator can insert the plug 2 into the plug receptacle 1 while avoiding reverse insertion.

(5) In this embodiment, the inclined sections 23a are formed at the lower portion of the insertion groove 23 (near the side 24c of the plug-receiving portion 24). Therefore, a sufficient distance between the inclined sections 23a and the pin insertion holes 25 can be obtained compared to a case that the inclined sections are formed at the upper portion of the insertion groove 23 (near the reference side 24b of the plug-receiving portion 24). This can increase strength of the plug-receiving portion 24 and suppress breakage of the plug-receiving portion 24 which may be caused by insertion and separation of the plug 2.

(6) In this embodiment, the portions of the plug-receiving portion 24 corresponding to the inclined sections 23a of the insertion groove 23 are inclined. Accordingly, the width of the insertion groove 23 is not decreased.

If the portions of the plug-receiving portion 24 which correspond to the inclined sections 23a of the insertion groove 23 are not inclined, only the outer periphery of the insertion groove 23 is inclined. Thus, the width between the outer periphery of the plug-receiving portion 24 and the outer periphery of the insertion groove 23 is decreased at the inclined sections 23a of the insertion groove 23. However, in this embodiment, the plug-receiving portion 24 has the inclined sections corresponding to the inclined sections 23a, so that the width of the insertion groove 23 is not decreased.

(7) In this embodiment, the inclined sections 23a of the insertion groove 23 are formed in accordance with the inclined shape of the plug-receiving portion 24. Therefore, a structure for preventing insertion of the plug 2 into the plug receptacle 1 for a different supply voltage can be obtained simply by slantingly cutting the corner or corners of the insertion groove 23 and the plug-receiving portion 24. Hence, the plug receptacle 1 can be easily manufactured.

(8) In this embodiment, the front surface 22a of the outlet unit 22 and the front surface 24a of the plug-receiving portion 24 are located on the same plane. Further, the electrode pins 51A of the plug 2 is not extended beyond the leading end of the surrounding wall 54 and the ground pin 51B is extended slightly beyond the leading end of the surrounding wall 54. Due to this configuration, when the plug 2 is reversely inserted into the outlet unit 22, the ground pin 51B contact with the plug-receiving portion 24 before the surrounding wall 54 is inserted into the insertion groove 23. Hence, an operator can recognize the reverse insertion of the plug 2 into the outlet unit 22, and the plug 2 is not connected to the outlet unit 22 in the reverse insertion state. Accordingly, it is possible to prevent the state in which the plug 2 is reversely inserted into the outlet unit 22.

(9) In this embodiment, the insertion groove 23 of the outlet unit 22 is provided with the surrounding wall holding portions 26 to be engaged with the engagement portions 55c of the plug 2. For that reason, the surrounding wall 54 of the plug 2 is supported by the insertion groove 23, and the state in which the plug 2 is inserted into the plug receptacle 1 can be maintained. As a consequence, the plug 2 can be prevented from being unintentionally separated from the plug receptacle 1 by pulling the cable portion 2A.

(10) In this embodiment, the surrounding wall holding portions 26 are disposed at both the left and the right sides of the two electrode-pin insertion holes 25A, so that the surrounding wall 54 can be stably held by the insertion groove 23 compared to a case that the engagement portion is formed at one side of the electrode-pin insertion holes 25A. As a result, the state in which the plug 2 is inserted into the plug receptacle 1 can be stably maintained.

(11) In this embodiment, the second inclined sections 55c2 of the engagement portions 55c of the plug 2 are inclined so as to be gradually widened toward the front side. Therefore, when the second inclined sections 55c2 contact with the outer wall 23c of the insertion groove 23 by the insertion of the plug 2 into the outlet unit 22, the second inclined sections 55c2 are gradually elastically deformed inwardly by reaction force of the contact between the second inclined sections 55c2 and the outer wall 23c. As a result, the engagement portions 55c can be engaged with the surrounding wall holding portions 26 without an operator's operation of gripping the locking units 55, which is convenient in use.

(12) In this embodiment, the locking units 55 and the surrounding wall 54 are formed as a unit. Therefore, the number of components constituting the plug 2 can be reduced compared to a case that the locking units 55 and the surrounding wall 54 are formed separately.

(13) In this embodiment, the outlet units 22 are arranged in the up-down direction, and the electrode-pin insertion holes 25A are arranged in the left-right direction. Further, the surrounding wall holding portions 26 are arranged in the left-right direction, so that the locking units 55 of the plug 2 are arranged in the left-right direction. Accordingly, when the plugs 2 are inserted into the outlet units 22 adjacent to each other in the up-down direction, the locking units 55 of the plugs 2 can be prevented from being adjacent to each other. This can suppress scaling up of the plug receptacle 1 in the up-down direction. Moreover, an operator does not need to insert the fingers between the plugs 2 adjacent to each other in the up-down direction, so that it is convenient to insert a plurality of plugs 2 into the plug receptacle 1.

(14) In this embodiment, the outlet units 22 are arranged in the up-down direction; the left or right electrode-pin insertion holes 25A of the outlet units 22 are positioned corresponding to each other in the up-down direction; and the ground-pin insertion holes 25B of the outlet units 22 are located corresponding to each other in the up-down direction. Hence, the pin-receiving pieces 13 respectively corresponding to the electrode-pin insertion holes 25A and the ground-pin insertion hole 25B are located corresponding to each other in the up-down direction, which enables the pin-receiving piece connection portion 12 for connecting the pin-receiving pieces 13 to have a flat plate shape extending in the up-down direction. In other words, the shape of the pin-receiving piece connection portion 12 can be simplified. As a result, scaling up of the plug receptacle 1 in the left-right direction can be suppressed.

### Second Embodiment

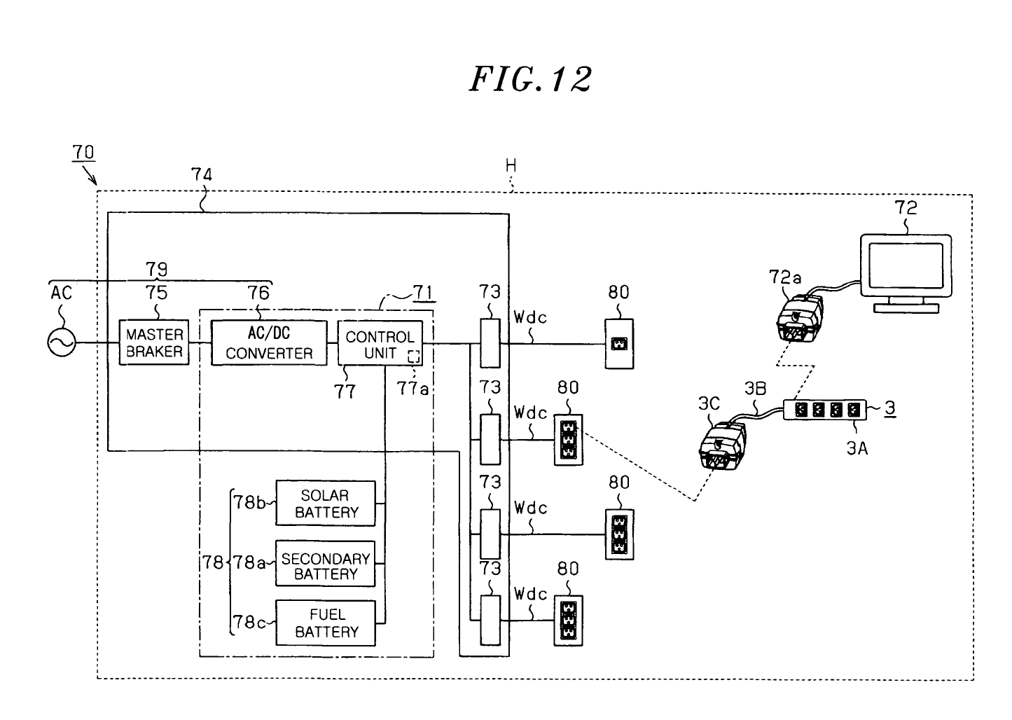

A second embodiment in which a plug receptacle of the present invention is embodied as a table tap connected to a DC outlet buried in a wall of a building will be described with reference to FIGS. 12 to 15. FIG. 15 omits illustration of the cable and the plug.

The entire DC power distribution system 70 installed at a house H will be described with reference to FIG. 12.

As shown in FIG. 12, the house H is provided with a DC power supply unit 71 for outputting a DC power; and an electric device 72 operating at a DC power. The DC power is supplied to the electric device 72 through DC power supply lines Wdc connected to an output terminal of the DC power supply unit 71.

Moreover, DC breakers 73 are provided between the DC power supply unit 71 and the electric device 72. The DC breakers 73 monitor a current flowing in the DC power supply lines Wdc and restrict or interrupt, when an error is detected, DC power supply from the DC power supply unit 71 to the electric device 72 through the DC power supply lines Wdc.

The DC power supply unit 71 basically generates a DC power by converting an AC power supplied from the outside of the house H. To be specific, the AC power from the AC power supply AC passes through a master breaker 75 installed in a power distributor 74. Then, the AC power is input to an AC/DC converter 76 including a switching power supply and is converted into DC power. The DC power output from the AC/DC converter 54 passes through a control unit 77 and then is input to the DC breakers 73. Moreover, the DC breakers 73 are connected to respective DC outlets 80 through the power supply lines Wdc.

The DC power supply unit 71 has a secondary battery 78a used for a time during which power is not supplied from the AC power supply (e.g., power supply failure period of the AC power supply or the like), a solar battery 56 for generating a DC power and a fuel battery 78c. The AC/DC converter 76 for generating a DC power from an AC power serves as a main power supply 79, whereas the solar battery 78a, the secondary battery 78b and the fuel cell 78c serve as a decentralized power source 78.

The control unit 77 controls distribution of the DC power from the main power supply 79 and the DC power from the decentralized power source 78. The control unit 77 has an AC/DC converter 77a for converting DC voltages of the DC power from the main power supply 79 and the decentralized power source 78 into required voltages. The DC power from the main power supply 79 and the decentralized power source 78 are distributed as required and supplied to the electric devices 77 via the DC outlets 80.

Here, the DC outlet 80 is connected to a plug 3C of a table tap 3 (hereinafter, referred to as a “tap 3”). By connecting a plug 72a of an electric device 72 to the outlet unit 22 of the plug receptacle 1, DC power from the DC power supply unit 71 is supplied to the electric device 72.

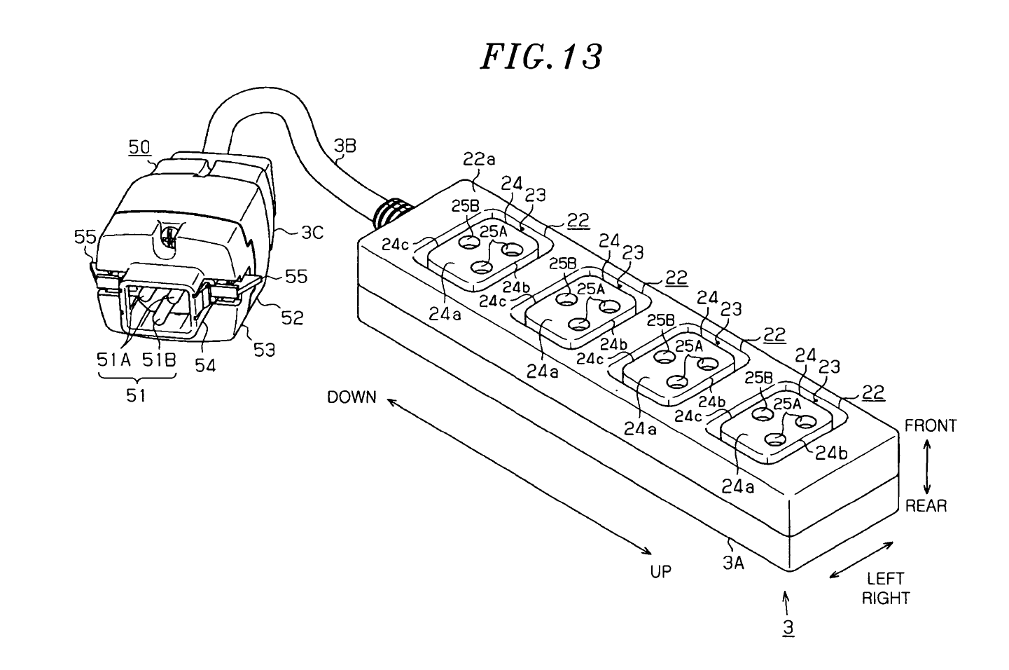

Hereinafter, a configuration of the tap 3 will be described with reference to FIG. 13. The tap 3 of this embodiment is different from the plug receptacle 1 of the first embodiment in that the number and the shape of the outlet units 22 are changed and the plug 3C is provided at the cable 3B. In the following description, the differences between the tap 3 and the plug receptacle 1 will be descried. Moreover, like reference numerals will be used for like parts as those of the first embodiment, and redundant description thereof will be omitted.

As illustrated in FIG. 13, the tap 3 include: a housing 3A; a power supply member (not shown) accommodated in the housing 3A; a cable 3B connected to the power supply member and extending from the housing 3A to the outside; and a plug 3C provided at the other end portion of the cable 3B opposite to the end portion connected to the power supply member. The housing 3A is provided with four outlet units 22 spaced from each other in the up-down direction. Further, the configurations of the power supply member and the plug 3C are substantially the same as those of the power supply member 1B and the plug 2 of the first embodiment.

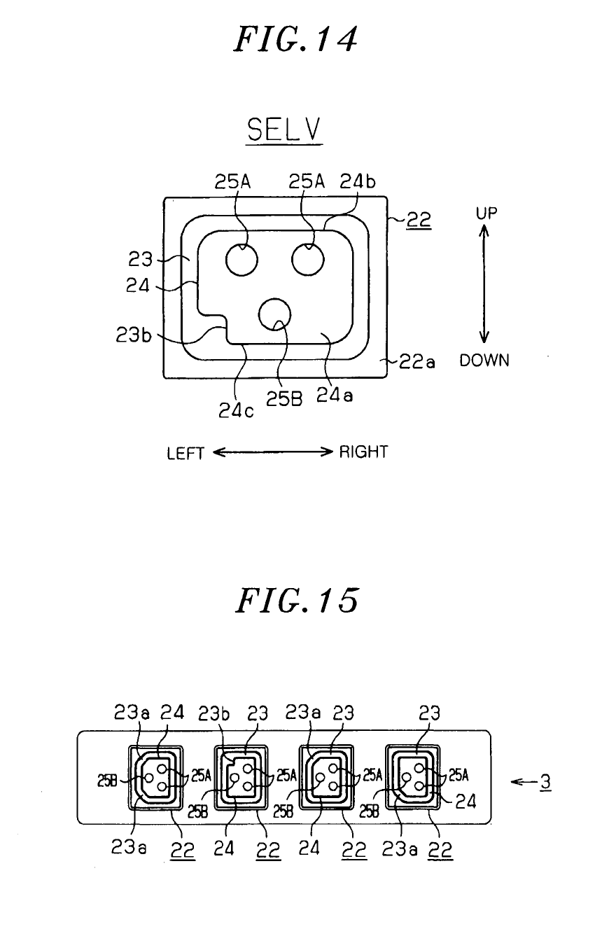

Next, the shape of the outlet unit 22 in accordance with the kinds of power supply circuits (not shown) as power supply sources will be described with reference to FIG. 14. The power supply circuits are provided between the DC power supply unit 71 and the DC outlet 80, e.g., inside the power distributor 74.

The power supply circuits include at least an ELV (extra-low voltage) circuit and an SELV (safety extra-low voltage) circuit. The ELV circuit and the SELV circuit are standardized by ICE 60950-1 and IEC 60335-1.

The electric device 72 (see FIG. 12) has different internal insulation structures depending on whether the power supply circuit is an ELV circuit or an SELV circuit. In other words, the electric device 72 for ELV employs a double insulation structure or a reinforced insulation structure. On the other hand, the electric device 72 for SELV may not employ a double insulation structure or a reinforced insulation structure and thus has a simpler insulation structure than that of the electric device 72 for ELV.

When the electric device 72 for ELV is connected to the tap 3 for SELV, problems are not generated due to the complicated insulation structure of the electric device 72. On the other hand, when the electric device for SELV is connected to the tap 3 for ELV, a problem in which the electric device 72 has a breakdown when a hazardous voltage is supplied thereto may be generated due to the simple insulation structure of the electric device 72. Therefore, the tap 3 and the plug 72a should be identified depending on whether they are suitable for ELV or SELV. Especially, the erroneous connection of the electric device 72 for SELV with the tap 3 for ELV should be prevented.

For that reason, in the outlet unit 22 for SELV, an extended groove 23b is formed at a lower left corner of the insertion groove 23, as illustrated in FIG. 14. The extended groove 23b is continuously extended upward from the lower side of the insertion groove 23. On the contrary, the outlet unit 22 for ELV is not provided with the extended groove 23b (see FIG. 13). In this manner, the outlet unit 22 for SELV and the outlet unit 22 for ELV can be identified.

Hence, the plug 72a for ELV can be inserted into the outlet unit 22 for SELV, whereas the plug 72a for SELV cannot be inserted into the outlet unit 22 for ELV. As a consequence, the connection between the tap 3 for ELV and the electric device 72 for SELV can be prevented.

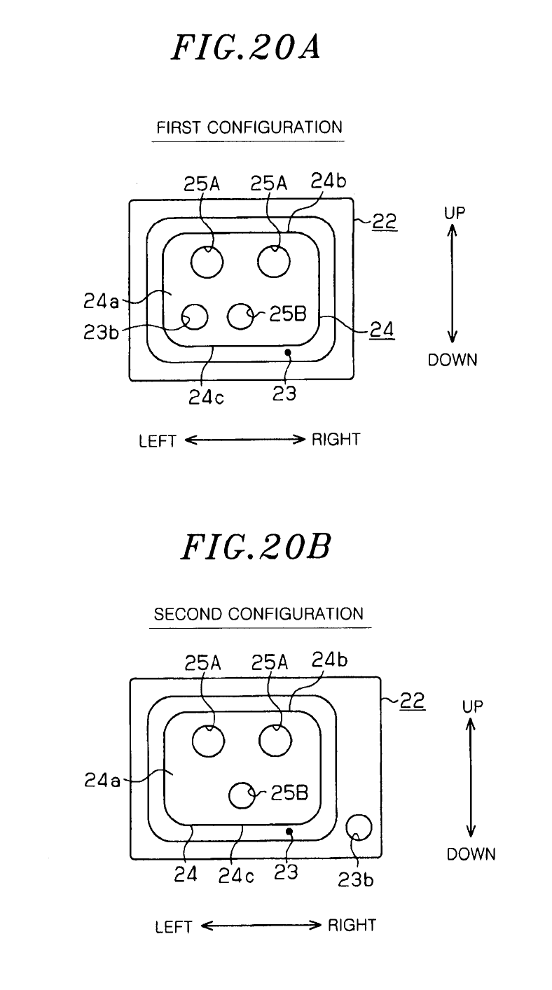

Further, the outlet unit can have another configuration in accordance with the kinds of power supply circuits, such as a configuration shown in FIG. 20A (first configuration) in which the extended groove 23b is formed separately from the insertion groove 23, or a configuration shown in FIG. 20B (second configuration) in which the extended groove 23b is formed outside the insertion groove 23, i.e., outside the plug-receiving portion 24.

However, the first configuration is disadvantageous in that the strength of the plug-receiving portion 24 decreases due to decrease in the distance between the extended groove 23b and the pin insertion holes 25. In the second configuration, although the strength of the plug-receiving portion 24 does not decrease, the outlet unit 22 is scaled up due to the space required for the extended groove 23b.

In this embodiment, the extended groove 23b is continuously extended from the insertion groove 23 at the lower portion of the insertion groove 23, so that the distance between the pin insertion holes 25 and the extended groove 23b is longer that that in the first configuration. Moreover, the extended groove 23b extends upward from the insertion groove 23 in the plug-receiving portion 24. Accordingly, the scaling up of the outlet unit 22 can be suppressed. That is, this embodiment can solve the problems of the first and the second configuration.

As shown in FIG. 15, the combination of the outlet units 22 of the tap 3 may include the outlet units 22 having a configuration for identifying the kinds of supply voltages and the outlet units 22 having a configuration for identifying the kinds of power supply circuits such as an SELV circuit and an ELV circuit. The combination of the outlet units 22 can be variously modified without being limited to that of FIG. 15.

This embodiment can provide the following effects in addition to the effects (1) to (14) of the first embodiment.

(15) In this embodiment, the extended groove 23b extends from the insertion groove 23, so that the scaling up of the outlet unit 22 or the decrease in strength of the plug-receiving portion 24 can be suppressed compared to a case that the extended groove 23b is formed separately from the insertion groove 23.

(16) In this embodiment, the extend groove 23b is formed at the lower side of the insertion groove 23 and, thus, the strength of the plug-receiving portion 24 can be improved compared to a case that the extended groove is formed between the pin insertion holes 25 and the insertion groove 23. This can suppress the breakage of the plug-receiving portion 24 which may be caused by insertion and separation of the plug 72a.

The plug receptacle 1 and the tap 3 can be variously modified without being limited to those of the aforementioned embodiments. The following modifications can be applied not only to the aforementioned embodiments but to an embodiment having combination of different modifications.

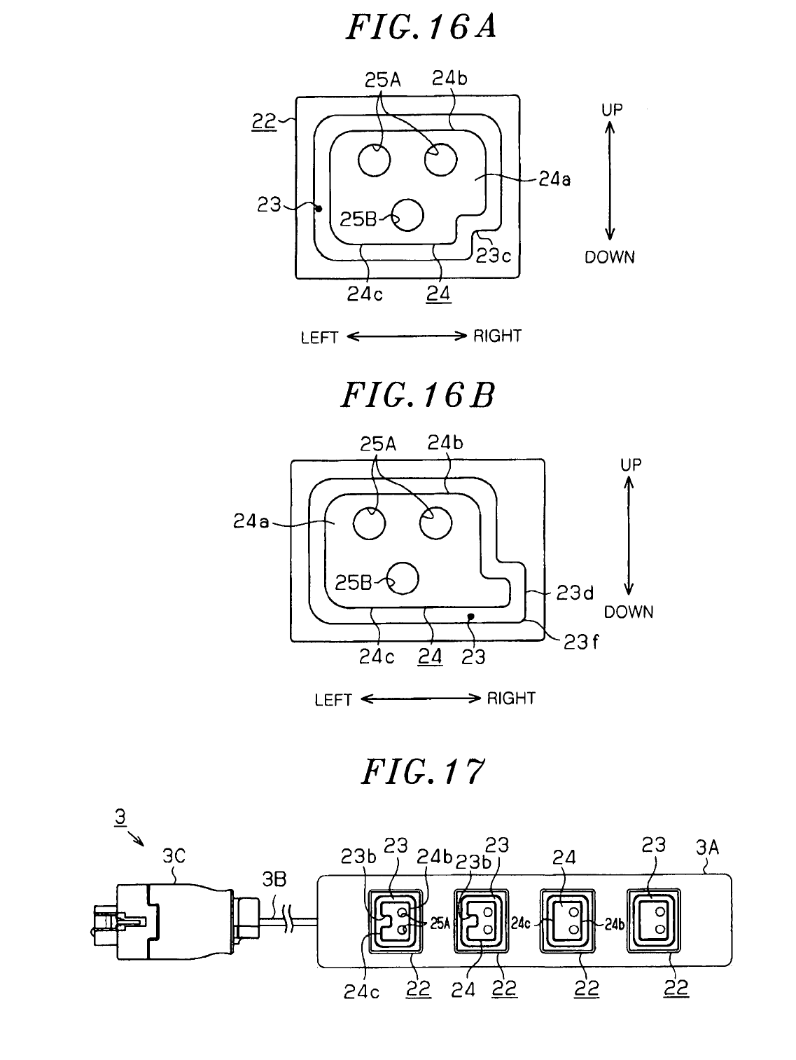

In the aforementioned embodiments, the supply voltages of the plug receptacle 1 and the tap 3 are identified by the inclined sections 23a of the insertion groove 23. However, the configuration for identifying the supply voltages of the plug receptacle 1 and the tap 3 is not limited thereto. The shape of the insertion groove 23 of the plug receptacle 1 and the tap 3 can be changed such that only the plug 2 and the surrounding wall 54 of the plug 72a for the same supply voltage as that of the plug receptacle 1 and the tap 3 can be inserted thereinto. For example, a stepped recess 23e can be formed by cutting one of four corners of the insertion groove 23, as shown in FIG. 16A. Besides, a protrusion 23f protruding outward can be formed after cutting a part of the insertion groove 23, as depicted in FIG. 16B. The shapes of the surrounding wall 54 of the plug 2 and the plug 72a viewed from the rear side are determined in accordance with the shape of the insertion groove 23.

Although the inclined sections 23a are formed at the lower side of the insertion groove 23 in the above-described embodiments, the inclined sections 23a can be formed at the upper side of the insertion groove 23

Besides, in the above-described embodiments, the lower portions 25a of the pin insertion holes 25 are positioned upper than the center C1 of the plug-receiving portion 24. However, the positions of the lower portions 25a are not limited thereto, and can be changed as long as it is possible to prevent the insertion of the plug pins 51 into the pin insertion holes 52 when the plug 2 and the plug 72a are reversely inserted into the plug receptacle 1 and the tap 3. The lower portions 25a can be positioned at substantially the same horizontal level as the center C1.

Although the insertion groove 23 and the plug-receiving portion 24 are formed in a rectangular shape in the aforementioned embodiments, the insertion groove 23 and the plug-receiving portion 24 may be formed in a square shape.

Further, in the aforementioned embodiments, the ground-pin insertion hole 25B of the outlet unit 22 is positioned at the same horizontal level as the center C1 of the plug-receiving portion 24 and vertically lower than the electrode-pin insertion holes 25A. However, the position of the ground-pin insertion hole 25B is not limited thereto. For example, the ground-pin insertion hole 25B can be deviated rightward or leftward from the center C1. Or, the ground-pin insertion hole 25B and the electrode-pin insertion holes 25A can be positioned at the substantially same height level.

In the second embodiment, the pin insertion holes 25 of the outlet unit 22 include the electrode-pin insertion holes 25A and the ground-pin insertion hole 25B. However, the configuration of the pin insertion holes 25 is not limited thereto. For example, the pin insertion holes 25 may include only the electrode-pin insertion holes 25A without the ground-pin insertion hole 25B, as can be seen from FIG. 17.

In the second embodiment, the extended portion 23b is formed at the lower left corner of the insertion groove 23. However, the position of the extended portion 23b is not limited thereto. For example, the extended groove 23b may be formed at the lower right corner of the insertion groove.

The extended groove 23b is not necessarily formed at the lower side of the insertion groove 23, and may be formed at any one of four sides of the insertion groove 23.

Moreover, the extended portion 23b is not necessarily provided at the plug-receiving portion 24. For example, the extended portion 23b may be provided at the front surface 22a of the outlet unit 22.

In the second embodiment, the extended groove 23b is formed at the lower left corner of the insertion groove 23. However, the position of the extended groove 23b is not limited thereto. For example, in the configuration shown in FIG. 17 in which the pin insertion holes 25 do not include the ground-pin insertion hole 25B, the extended groove 23b can be formed at a lower central portion of the insertion groove 23. In this configuration, the extended groove 23b can be formed at the lower central portion of the insertion groove 23 regardless of types of supply voltages.

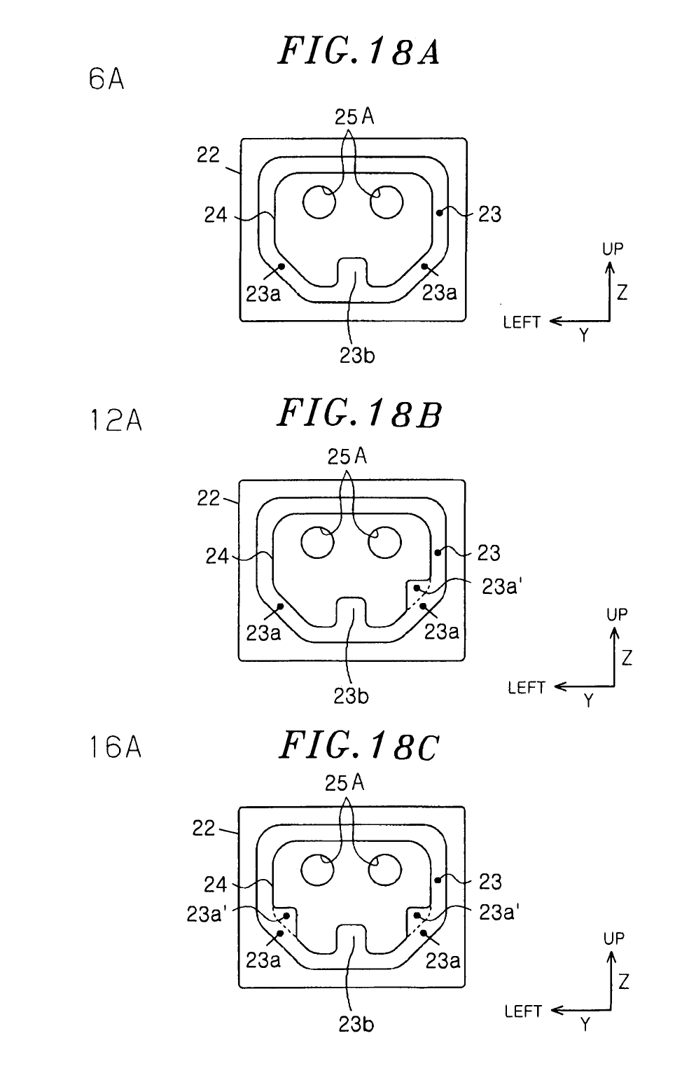

In the above embodiments, the shape of the insertion groove 23 of the outlet unit 22 is changed depending on the kinds of supply voltages and/or the kinds of power supply circuits. However, the shape of the insertion groove 23 of the outlet unit 22 may be partially changed depending on the kinds of supply currents, as illustrated in FIGS. 18A to 18C.

FIGS. 18A to 18C show the outlet unit for SELV and 48V as an example.

The electrical devices require a plurality of supply currents, e.g., 6A, 12A and 16A. In this embodiment, in order to identify the outlet unit 22 in accordance with the types of supply currents, the shape of the insertion groove viewed from the front side is changed by forming an extended groove 23a′ at the insertion groove 23. To be specific, in case of the supply current of 6A, an extended groove is not formed as shown in FIG. 18A.

In case of the supply current of 12A, an extended groove 23a′ having a triangular cross section extends inward in the left-right direction (Y direction) at an upper portion of the right inclined section 23a, as illustrated in FIG. 18B. In case of the supply current of 16A, the extended portions 23a′ are formed at both of the inclined sections 23a, as shown in FIG. 18C. When the inclined sections 23 are not formed at the insertion groove 23, the extended groove 23a′ has a quadrangular cross section viewed from the front side.

The outlet unit can be identified in accordance with the kinds of power supply circuits such as an SELV circuit and an ELV circuit in addition to the kinds of supply currents and supply voltages. To do so, the extended portion 23b can be formed at the outlet unit 22 for SELV, as shown in FIGS. 18A to 18C.

Various examples of changing the shape of the insertion groove 23 of the outlet unit 22 in accordance with the kinds of supply voltages, supply currents or power supply circuits are described in PCT Application No. PCT/IB2010/001892 filed by the present Applicant, the contents of which are incorporated herein by reference.

In the aforementioned embodiments, the surrounding wall holding portions 26 to be engaged with the locking units 55 are formed at both of the left and the right sides of the insertion groove 23. However, the positions of the surrounding wall insertion portions 26 are not limited thereto. For example, the surrounding wall holding portions 26 may be formed at both of the upper and lower sides of the insertion groove 23. In that case, the same effect (9) of the first embodiment can be obtained.

While the invention has been shown and described with respect to the embodiments, it will be understood by those skilled in the art that various changes and modification may be made without departing from the scope of the invention as defined in the following claims.

What is claimed is:

1. A plug receptacle comprising a housing having at least one outlet unit to which a plug is adapted to be connected to supply a DC power to the plug, the plug including a plurality of plug pins having a circular bar shape; and a substantially quadrangular-shaped surrounding wall for surrounding the plug pins; and a cable, connected to the housing, for supplying the DC power to the housing, wherein:
the outlet unit includes a plug-receiving portion having a plurality of substantially circular pin-inserting holes into which the plug pins of the plug are inserted, the plug-receiving portion having a substantially quadrangular shape viewed from a front side thereof; and an insertion groove formed to surround a periphery of the plug-receiving portion, the insertion groove being adapted to receive the surrounding wall of the plug and having a substantially quadrangular shape viewed from the front side; and
the pin-receiving holes are arranged along one side of the plug-receiving portion serving as a reference side and offset closer to the reference side than an opposite side to the reference side.

2. The plug receptacle of claim 1, wherein a shape of at least one of the plug-receiving portion and the insertion groove, viewed from the front thereof, is partially changed depending on the kinds of a supply voltage or a supply current.

3. The plug receptacle of claim 2, wherein the shape of the insertion groove viewed from the front is changed such that an area of the plug-receiving portion is decreased as compared with a case that the plug-receiving portion has the substantially quadrangular shape viewed from the front.

4. The plug receptacle of claim 3, wherein the shape of the insertion groove viewed from the front is changed differently depending on the kinds of the supply voltage or the supply current by cutting at least one corner of the substantially quadrangular shape of the plug-receiving portion depending on the kinds of the supply voltage or the supply current, and forming the insertion groove along an outer periphery of the plug-receiving portion.

5. The plug receptacle of claim 2, wherein a portion of the insertion groove whose shape is changed depending on the kinds of the supply voltage or the supply current is closer to the opposite side to the reference side than the reference side.

6. The plug receptacle of claim 2, wherein the shape of the insertion groove viewed from the front is changed such that an area of the plug-receiving portion is increased as compared with a case that the plug-receiving portion has the substantially quadrangular shape viewed from the front.

7. The plug receptacle of claim 2 or 4, wherein the shape of the insertion groove viewed from the front is partially changed by forming an extension groove extending from the insertion groove.

8. The plug receptacle of claim 7, wherein the extension groove is formed by extending a part of the insertion groove into the plug-receiving portion.

9. The plug receptacle of claim 7, wherein the extension groove is provided closer to the opposite side to the reference side of the plug-receiving portion than the reference side.

10. The Plug receptacle of claim 7, wherein the extension groove is formed on the front surface of the outlet main body by outwardly extending a part of the insertion groove.

11. The plug receptacle of claim 1, wherein a shape of at least one of the plug-receiving portion and the insertion groove, viewed from the front thereof, is partially changed depending on the kinds of a power supply circuit serving as a power supply source.

12. The plug receptacle of claim 11, wherein the shape of the insertion groove viewed from the front is changed such that an area of the plug-receiving portion is decreased as compared with a case that the plug-receiving portion has the substantially quadrangular shape viewed from the front.

13. The plug receptacle of claim 12, wherein the shape of the insertion groove viewed from the front is changed differently depending on the kinds of the power supply circuit by cutting at least one corner of the substantially quadrangular shape of the plug-receiving portion depending on the kinds of the power supply circuit, viewed from the front, and forming the insertion groove along an outer periphery of the plug-receiving portion.

14. The plug receptacle of claim 11, wherein a portion of the insertion groove whose shape is changed depending on the kinds of the power supply circuit is closer to the opposite side to the reference side than the reference side.

15. The plug receptacle of claim 11, wherein the shape of the insertion groove viewed from the front is changed such that an area of the plug-receiving portion is increased as compared with a case that the plug-receiving portion has the substantially quadrangular shape viewed from the front.

16. The plug receptacle of claim 11 or 13, wherein the shape of the insertion groove viewed from the front is partially changed by forming an extension groove extending from the insertion groove.

17. The plug receptacle of claim 16, wherein the extension groove is formed by extending a part of the insertion groove into the plug-receiving portion.

18. The plug receptacle of claim 16, wherein the extension groove is provided closer to the opposite side to the reference side of the plug-receiving portion than the reference side.

19. The plug receptacle of claim 16, wherein the extension groove is formed on the front surface of the outlet main body by outwardly extending the insertion groove.

20. The plug receptacle of claim 11, wherein the shape of the insertion groove viewed from the front is partially changed only when the power supply circuit is a safety extra low voltage (SELV) circuit.

21. The plug receptacle of claim 1, wherein the plug pins of the plug include a ground pin, and the pin-inserting holes of the plug-receiving portion include a ground pin inserting hole into which the ground pin of the plug is inserted.

22. The plug receptacle of claim 21, wherein the ground pin inserting hole is provided offset closer to the opposite side to the reference side.
